(19) United States
(12) Patent Application Publication
(10) Pub. No.: US 2024/0028360 A1
(43) Pub. Date: Jan. 25, 2024

(54) SYSTEMS, APPARATUS, ARTICLES OF MANUFACTURE, AND METHODS FOR SCHEDULE-BASED LIFECYCLE MANAGEMENT OF A VIRTUAL COMPUTING ENVIRONMENT

(71) Applicant: VMware, Inc., Palo Alto, CA (US)

(72) Inventors: Stoyan Genchev, Sofia (BG); Plamen Peev, Sofia (BG); Dimo Stanev, Sofia (BG); Nikola Bratanov, Sofia (BG)

(21) Appl. No.: 17/869,584

(22) Filed: Jul. 20, 2022

(51) Int. Cl. G06F 9/455; G06F 9/48; G06F 9/50

(52) U.S. Cl. CPC G06F 9/45558; G06F 9/4881; G06F 9/50

(57) ABSTRACT

Methods, apparatus, systems, and articles of manufacture are disclosed for schedule-based lifecycle management of a virtual computing environment. An example apparatus includes at least one memory, machine readable instructions, and processor circuitry to at least one of execute or instantiate the machine readable instructions to at least generate a schedule including a rule, the rule to trigger an operation associated with a virtual resource of the virtualized environment, identify the virtual resource after a first determination that the rule corresponds to the virtual resource, and execute the operation after a second determination that a value of a utilization parameter of the virtual resource satisfies a threshold.

### FIELD OF THE DISCLOSURE

This disclosure relates generally to cloud computing and, more particularly, to systems, apparatus, articles of manufacture, and methods for schedule-based lifecycle management of a virtual computing environment.

### BACKGROUND

Virtualizing computer systems provides benefits such as the ability to execute multiple computer systems on a single hardware computer, replicating computer systems, moving computer systems among multiple hardware computers, and so forth. “Infrastructure-as-a-Service” (also commonly referred to as “IaaS”) generally describes a suite of technologies provided by a service provider as an integrated solution to allow for elastic creation of a virtualized, networked, and pooled computing platform (sometimes referred to as a “cloud computing platform”). Enterprises may use IaaS as a business-internal organizational cloud computing platform (sometimes referred to as a “private cloud”) that gives an application developer access to infrastructure resources, such as virtualized servers, storage, and network resources. By providing ready access to the hardware resources required to run an application, the cloud computing platform enables developers to build, deploy, and manage the lifecycle of a web application (or any other type of networked application) at a greater scale and at a faster pace than ever before.

Cloud computing environments may be composed of many processing units (e.g., servers, computing resources, etc.). The processing units may be installed in standardized frames, known as racks, which provide efficient use of floor space by allowing the processing units to be stacked vertically. The racks may additionally include other components of a cloud computing environment such as storage devices, network devices (e.g., routers, switches, etc.), etc.

### BRIEF DESCRIPTION OF THE DRAWINGS

FIG. 1 is an illustration of an example virtualized environment including an example lifecycle management controller to effectuate schedule-based lifecycle management of the virtualized environment.

FIG. 2 is a block diagram of an example implementation of the lifecycle management controller of FIG. 1.

FIG. 3 is a first example workflow to effectuate schedule-based lifecycle management.

FIG. 4 is a second example workflow to effectuate schedule-based lifecycle management.

FIG. 5 is a third example workflow to effectuate schedule-based lifecycle management.

FIG. 6 is a first example graphical user interface (GUI) to create an example schedule.

FIG. 7 is a second example GUI to create an example schedule.

FIG. 8 is a third example GUI to create an example schedule.

FIG. 9 is a flowchart representative of example machine readable instructions and/or example operations that may be executed by example processor circuitry to implement the example lifecycle management controller of FIGS. 1 and/or 2 to effectuate schedule-based lifecycle management of a virtual resource in a virtualized environment.

FIG. 10 is another flowchart representative of example machine readable instructions and/or example operations that may be executed by example processor circuitry to implement the example lifecycle management controller of FIGS. 1 and/or 2 to effectuate schedule-based lifecycle management of a virtual resource in a virtualized environment.

FIG. 11 is a flowchart representative of example machine readable instructions and/or example operations that may be executed by example processor circuitry to implement the example lifecycle management controller of FIGS. 1 and/or 2 to generate an example schedule.

FIG. 12 is a flowchart representative of example machine readable instructions and/or example operations that may be executed by example processor circuitry to implement the example lifecycle management controller of FIGS. 1 and/or 2 to execute an action after invoking a rule of a schedule.

FIG. 13 is a flowchart representative of example machine readable instructions and/or example operations that may be executed by example processor circuitry to implement the example lifecycle management controller of FIGS. 1 and/or 2 to execute an action based on a utilization parameter of a virtual resource.

FIG. 14 is a block diagram of an example processing platform including processor circuitry structured to execute the example machine readable instructions and/or the example operations of FIGS. 9-13 to implement the example lifecycle management controller of FIGS. 1 and/or 2.

FIG. 15 is a block diagram of an example implementation of the processor circuitry of FIG. 14.

FIG. 16 is a block diagram of another example implementation of the processor circuitry of FIG. 14.

FIG. 17 is a block diagram of an example software distribution platform (e.g., one or more servers) to distribute software (e.g., software corresponding to the example machine readable instructions of FIGS. 9-13) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale.

### DETAILED DESCRIPTION

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

Cloud computing is based on the deployment of many physical resources across a network, virtualizing the physical resources into virtual resources, and provisioning the virtual resources in software defined data centers (SDDCs) for use across cloud computing services and applications. Examples disclosed herein can be used to manage network resources in SDDCs to improve performance and efficiencies of network communications between different virtual and/or physical resources of the SDDCs.

Examples disclosed herein can be used in connection with different types of SDDCs. In some examples, techniques disclosed herein are useful for managing network resources that are provided in SDDCs based on Hyper-Converged Infrastructure (HCI). In some examples, HCI combines a virtualization platform such as a hypervisor, virtualized software-defined storage, and virtualized networking in an SDDC deployment. An SDDC manager can provide automation of workflows for lifecycle management and operations of a self-contained private cloud instance. Such an instance may span multiple racks of servers connected via a leaf-spine network topology and connects to the rest of the enterprise network for north-south connectivity via well-defined points of attachment. The leaf-spine network topology is a two-layer data center topology including leaf switches (e.g., switches to which servers, load balancers, edge routers, storage resources, etc., connect) and spine switches (e.g., switches to which leaf switches connect, etc.). In such a topology, the spine switches form a backbone of a network, where every leaf switch is interconnected with each and every spine switch.

Examples disclosed herein can be used with one or more different types of virtualization environments. Three example types of virtualization environments are: full virtualization, paravirtualization, and operating system (OS) virtualization. Full virtualization, as used herein, is a virtualization environment in which hardware resources are managed by a hypervisor to provide virtual hardware resources to a virtual machine (VM). In a full virtualization environment, the VMs do not have access to the underlying hardware resources. In a typical full virtualization, a host OS with embedded hypervisor (e.g., a VMWARE® ESXI® hypervisor, etc.) is installed on the server hardware. VMs including virtual hardware resources are then deployed on the hypervisor. A guest OS is installed in the VM. The hypervisor manages the association between the hardware resources of the server hardware and the virtual resources allocated to the VMs (e.g., associating physical random-access memory (RAM) with virtual RAM, etc.). Typically, in full virtualization, the VM and the guest OS have no visibility and/or access to the hardware resources of the underlying server. Additionally, in full virtualization, a full guest OS is typically installed in the VM while a host OS is installed on the server hardware. Example virtualization environments include VMWARE® ESX® hypervisor, VMWARE® ESXi® hypervisor, Microsoft HYPER-V® hypervisor, and Kernel Based Virtual Machine (KVM).

Paravirtualization, as used herein, is a virtualization environment in which hardware resources are managed by a hypervisor to provide virtual hardware resources to a VM, and guest OSs are also allowed to access some or all the underlying hardware resources of the server (e.g., without accessing an intermediate virtual hardware resource, etc.). In a typical paravirtualization system, a host OS (e.g., a Linux-based OS, etc.) is installed on the server hardware. A hypervisor (e.g., the XEN® hypervisor, etc.) executes on the host OS. VMs including virtual hardware resources are then deployed on the hypervisor. The hypervisor manages the association between the hardware resources of the server hardware and the virtual resources allocated to the VMs (e.g., associating RAM with virtual RAM, etc.). In paravirtualization, the guest OS installed in the VM is configured also to have direct access to some or all of the hardware resources of the server. For example, the guest OS can be precompiled with special drivers that allow the guest OS to access the hardware resources without passing through a virtual hardware layer. For example, a guest OS can be precompiled with drivers that allow the guest OS to access a sound card installed in the server hardware. Directly accessing the hardware (e.g., without accessing the virtual hardware resources of the VM, etc.) can be more efficient, can allow for performance of operations that are not supported by the VM and/or the hypervisor, etc.

OS virtualization is also referred to herein as container virtualization. As used herein, OS virtualization refers to a system in which processes are isolated in an OS. In a typical OS virtualization system, a host OS is installed on the server hardware. Alternatively, the host OS can be installed in a VM of a full virtualization environment or a paravirtualization environment. The host OS of an OS virtualization system is configured (e.g., utilizing a customized kernel, etc.) to provide isolation and resource management for processes that execute within the host OS (e.g., applications that execute on the host OS, etc.). The isolation of the processes is known as a container. Thus, a process executes within a container that isolates the process from other processes executing on the host OS. Thus, OS virtualization provides isolation and resource management capabilities without the resource overhead utilized by a full virtualization environment or a paravirtualization environment. Example OS virtualization environments include Linux Containers LXC and LXD, the DOCKER™ container platform, the OPENVZ™ container platform, etc.

In some examples, a data center (or pool of linked data centers) can include multiple different virtualization environments. For example, a data center can include hardware resources that are managed by a full virtualization environment, a paravirtualization environment, an OS virtualization environment, etc., and/or any combination(s) thereof. In such a data center, a workload can be deployed to any of the virtualization environments. In some examples, techniques to monitor both physical and virtual infrastructure, provide visibility into the virtual infrastructure (e.g., VMs, virtual storage, virtual or virtualized networks and their control/management counterparts, etc.) and the physical infrastructure (e.g., servers, physical storage, network switches, etc.).

Examples disclosed herein can be employed with HCI-based SDDCs deployed using virtual server rack systems. A virtual server rack system can be managed using a set of tools that is accessible to all modules of the virtual server rack system. Virtual server rack systems can be configured in many different sizes. Some systems are as small as four hosts, and other systems are as big as tens of racks. Multi-rack deployments can include Top-of-the-Rack (ToR) switches (e.g., leaf switches, etc.) and spine switches connected using a Leaf-Spine architecture. A virtual server rack system also includes software-defined data storage (e.g., storage area network (SAN), VMWARE® VIRTUAL SAN™, etc.) distributed across multiple hosts for redundancy and virtualized networking software (e.g., VMWARE NSX™ etc.).

A drawback of some virtual server rack systems is that different hardware components located therein can be procured from different equipment vendors, and each equipment vendor can have its own independent OS installed on its hardware. For example, physical hardware resources include white label equipment such as white label servers, white label network switches, white label external storage arrays, and white label disaggregated rack architecture systems (e.g., Intel's Rack Scale Architecture (RSA), etc.). White label equipment is computing equipment that is unbranded and sold by manufacturers to system integrators that install customized software, and possibly other hardware, on the white label equipment to build computing/network systems that meet specifications of end users or customers. The white labeling, or unbranding by original manufacturers, of such equipment enables third-party system integrators to market their end-user integrated systems using the third-party system integrators' branding.

In some examples, virtual server rack systems additionally manage non-white label equipment such as original equipment manufacturer (OEM) equipment. Such OEM equipment includes OEM servers such as HEWLETT-PACKARD® (HP®) servers and LENOVO® servers, and OEM switches such as switches from ARISTA NETWORKS™, and/or any other OEM server, switches, or equipment. In any case, each equipment vendor can have its own independent OS installed on its hardware. For example, ToR switches and spine switches can have OSs from vendors like CISCO® and ARISTA NETWORKS, while storage and compute components may be managed by a different OS. Each OS actively manages its hardware at the resource level but there is no entity across all resources of the virtual server rack system that makes system-level runtime decisions based on the state of the virtual server rack system. For example, if a hard disk malfunctions, storage software has to reconfigure existing data into the remaining disks. This reconfiguration can require additional network bandwidth, which may not be released until the reconfiguration is complete.

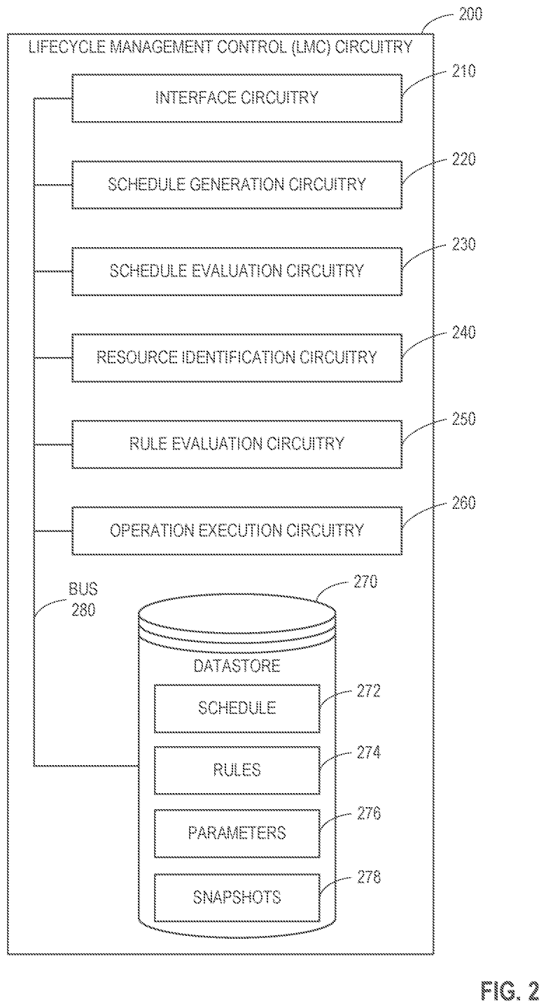

Examples disclosed herein provide HCI-based SDDCs with system-level governing features that can actively monitor and manage different hardware and software components of a virtual server rack system even when such different hardware and software components execute different OSs. As described in connection with FIG. 2, major components of a virtual server rack system can include a hypervisor, network virtualization software, storage virtualization software (e.g., software-defined data storage, etc.), a physical network OS, and external storage. In some examples, the storage virtualization (e.g., VMWARE VIRTUAL SAN™, etc.) is integrated with the hypervisor. In examples in which the physical network OS is isolated from the network virtualization software, the physical network is not aware of events occurring in the network virtualization environment and the network virtualization environment is not aware of events occurring in the physical network.

When starting up a cloud computing environment or adding resources to an already established cloud computing environment, data center operators struggle to offer cost-effective services while making resources of the infrastructure (e.g., storage hardware, computing hardware, and networking hardware) work together to achieve simplified installation/operation and optimize the resources for improved performance. Prior techniques for establishing and maintaining data centers to provide cloud computing services often require customers to understand details and configurations of hardware resources to establish workload domains in which to execute customer services. As used herein, the term “workload domain” refers to virtual hardware policies or subsets of virtual resources of a VM mapped to physical hardware resources to execute a user application. For example, a workload domain can include one or more virtual resources, or portion(s) thereof, that can be utilized to execute a user application. In some examples, a workload domain can include a first VM including a first quantity of virtualized hardware resources (e.g., virtualized central processing units (CPUs), memories, mass storage discs or devices, security devices, hardware accelerators, switches, gateways, network interface cards (NICs), etc.), a second VM including a second quantity of virtualized hardware resources, etc., and/or any combination(s) thereof.

In some disclosed examples, data center operators have hundreds or thousands of resources (e.g., physical hardware resources such as servers or portion(s) thereof, virtualized hardware resources such as virtualized server racks, virtualized servers, etc., or portion(s) thereof, etc.) under management in their organizations. Such data center operators can start up, deploy, and/or maintain a cloud computing environment via different stages of operations. For example, data center operators can design a cloud computing environment in a design stage, which can be implemented via Day 0 operations, such as identifying the resources and/or requirements needed to start up the cloud computing environment. In some examples, the data center operators can deploy the cloud computing environment in a deploy or deployment stage, which can be implemented via Day 1 operations, such as installing, setting up, and/or configuring physical hardware resources (e.g., installing physical server racks, connecting power and/or network cables, etc.) and/or software resources (e.g., OS, applications, drivers, services, libraries, VMs, containers, etc.). In some examples, the data center operators can maintain the cloud computing environment in a maintenance stage, which can be implemented by Day 2 operations, such as prognostic health monitoring of resources (e.g., predicting or anticipating failures to be mitigated during scheduled maintenance), installing upgrades, updating systems, etc.

Managing Day 2 operations can be challenging as cloud computing environments are scaled to hundreds or thousands of resources. With such a substantial number of resources to manage, data center operators may have difficulty visualizing the performance of their systems and integrating updates. In some instances, data center operators may tediously carry out Day 2 operations resource-by-resource or cloud provider-by-cloud provider (if the data center operators have a heterogeneous cloud computing deployment, such as a deployment using two or more different cloud providers). In some instances, data center operators may have to carry out Day 2 operations on a regular or periodic basis, which can be substantially time consuming and inefficient.

Examples disclosed herein include schedule-based lifecycle management of virtualized environments. For example, the lifecycle of an application to be executed and/or instantiated by virtual resource(s) of a virtualized environment can include the configuration of the application, the provisioning and/or allocation of the virtual resource(s) to a workload domain to execute the application, the execution of the application, and/or the decommissioning or termination of the application (and/or, more generally, the workload domain) that can include releasing the virtual resource(s) from the application and back to a virtual resource pool.

In some disclosed examples, a lifecycle management controller can generate a schedule associated with virtual resource(s) that can be periodically checked to determine whether action(s) or operation(s) is/are to be performed or carried out in connection with the virtual resource(s). In some disclosed examples, the schedule can be implemented by a rules engine that evaluates rule(s) of the schedule to find matching virtual resource(s) to which operation(s) specified by the rule(s) is/are to be performed. For example, the lifecycle management controller can generate a schedule to include a rule (e.g., a schedule rule) that can be applied to a virtual resource, such as a VM. In some disclosed examples, the lifecycle management controller can specify the rule to be applicable to a virtual resource that matches a specific project, owner, set of tags (e.g., developer or user generated tags, data tags, metadata, metadata tags, etc.), and/or a value of a utilization parameter.

By way of example, the lifecycle management controller can determine that a time period has elapsed after which a schedule is to be evaluated. In some disclosed examples, the lifecycle management controller can determine that the schedule includes a rule to be enforced and/or otherwise be applicable to virtual resource(s) that is/are included in a first project, have a first owner, match explicitly one or more tags, and have a CPU utilization value of less than 30% (e.g., a CPU utilization value of less than 30% for a specific time period, such as the previous 24 hours, the previous 48 hours, etc.). In some disclosed examples, the lifecycle management controller can determine that the rule is applicable to a VM in a first workload domain.

Advantageously, the lifecycle management controller can execute one or more actions (e.g., schedule actions), operations (e.g., schedule operations), etc., associated with the VM to effectuate schedule-based lifecycle management of a virtual environment (e.g., a virtual computing environment). For example, the lifecycle management controller can resize (e.g., upsize, downsize, etc.) the VM based on whether the VM is underutilized or overutilized. For example, the lifecycle management controller can upsize a VM by adding resources (e.g., compute, network or networking, storage, etc., resources) to the VM or downsize a VM by removing resources (e.g., compute, network or networking, storage, etc., resources) from the VM. In some disclosed examples, the lifecycle management controller can power on or off the VM. In some disclosed examples, the lifecycle management controller can create snapshots of the VMs to achieve improved failure recovery or backup recovery features.

Advantageously, the example lifecycle management controller can enforce rule(s) on virtual resource(s) based on value(s) of parameter(s) associated with the virtual resource(s). For example, the parameter can be an availability parameter (e.g., a parameter representative of availability), a performance parameter (e.g., a parameter representative of performance), a capacity parameter (e.g., a parameter representative of capacity), a utilization parameter (e.g., a parameter representative of utilization), or any other type of parameter.

As used herein, availability refers to the level of redundancy required to provide continuous operation expected for a workload domain. For example, a value of an availability parameter can be 0 (zero) to represent no availability, which can correspond to a virtual resource having no backup or failover resources in case of failure of the virtual resource. In some disclosed examples, a value of an availability parameter can be 1 (one) to represent low or medium availability, which can correspond to a virtual resource having at least one backup or failover resource (e.g., at least one idle or non-used VM of which the failed VM may failover to) in case of failure of the virtual resource. In some disclosed examples, a value of an availability parameter can be 2 (two) to represent high availability, which can correspond to a virtual resource having at least two backup or failover resources (e.g., at least two idle or non-used VMs to which the failed VM may failover) in case of failure of the virtual resource.

As used herein, performance refers to the CPU operating speeds (e.g., CPU gigahertz (GHz)), memory (e.g., gigabytes (GB) of random access memory (RAM)), mass storage (e.g., GB hard drive disk (HDD), GB solid state drive (SSD), etc.), and power capabilities of a workload domain. As used herein, capacity refers to the aggregate number of resources (e.g., aggregate storage, aggregate CPU, aggregate respective hardware accelerators (e.g., field programmable gate arrays (FPGAs), graphics processing units (GPUs)), etc.) across all servers associated with a cluster and/or a workload domain. In some disclosed examples, resources are computing or electronic devices with set amounts of storage, memory, CPUs, etc., and/or any combination(s) thereof. In some disclosed examples, resources are individual devices (e.g., hard drives, processors, memory chips, etc.).

As used herein, utilization refers to a usage of a virtual resource, or portion(s) thereof. For example, the utilization can be a compute or processing utilization (e.g., 20% of the processing power of a virtualized CPU is utilized, 60% of the processing power of a hardware accelerator such as a GPU is utilized, etc.), a storage utilization (e.g., 40% of the storage capacity of a virtualized SSD is utilized), a memory utilization (e.g., 35% of a virtualized memory is utilized), a network utilization (e.g., 80% of the bandwidth, throughput, etc., of a virtualized switch, gateway, etc., is utilized), etc., and/or any combination(s) thereof.

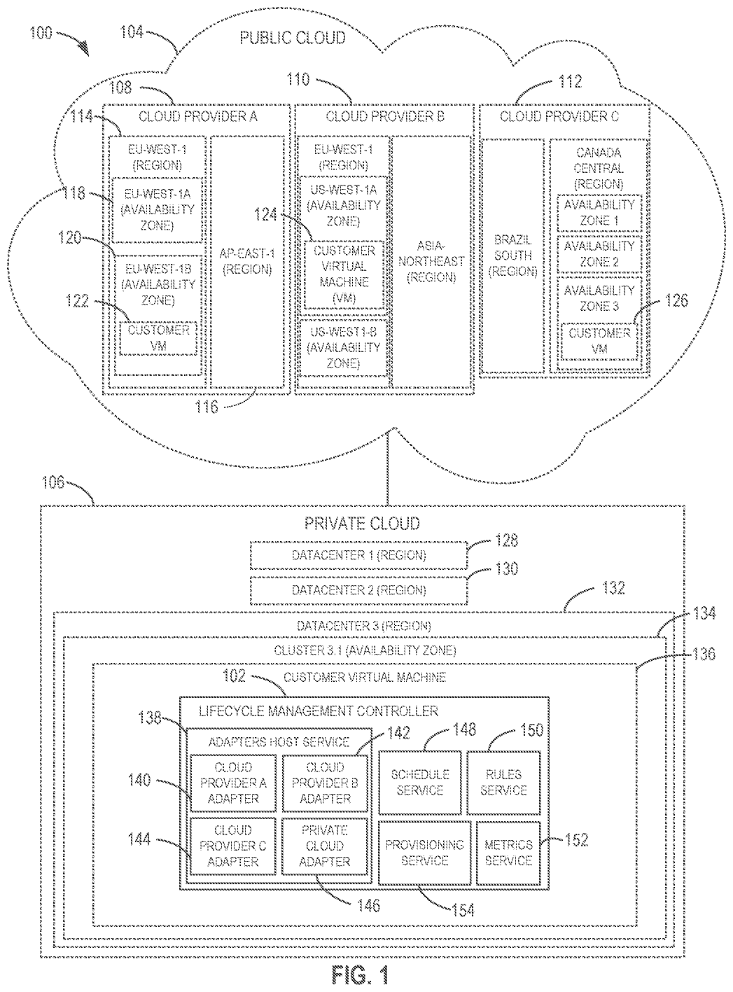

FIG. 1 is an illustration of an example virtualized environment 100 including an example lifecycle management controller 102 to effectuate schedule-based lifecycle management of the virtualized environment. The virtualized environment 100 includes an example public cloud 104 and an example private cloud 106. In some examples, the public cloud 104 can be cloud computing services operated by public entities. For example, the public cloud 104 can include suites of technologies provided by different service providers as integrated solutions to allow for elastic creation of a virtualized, networked, and pooled computing platform (sometimes referred to as a “cloud computing platform”). In some examples, the public cloud 104 can include Azure® cloud computing service offered by Microsoft Corporation, Google Cloud Platform™ service offered by Google LLC, Amazon Web Services (AWS) offered by Amazon Web Services, Inc., or the like.

The public cloud 104 of the illustrated example includes a first example cloud provider 108 (identified by CLOUD PROVIDER A), a second example cloud provider 110 (identified by CLOUD PROVIDER B), and a third example cloud provider 112 (identified by CLOUD PROVIDER C). For example, each of the cloud providers 108, 110, 112 can be associated with a different cloud computing entity.

The cloud providers 108, 110, 112 of the illustrated example have physical hardware resources (e.g., servers) in example geographical regions 114, 116. The geographical regions 114, 116 of the illustrated example can be further broken down, divided, partitioned, etc., into example subregions 118, 120. For example, the first cloud provider 108 of the illustrated example has physical servers in an example geographical region 114 (identified by EU-WEST-1 (REGION)), which is partitioned into a first example subregion 118 (identified by EU-WEST-1A (AVAILABILITY ZONE)) and a second example subregion 118 (identified by EU-WEST-1B (AVAILABILITY ZONE). The subregions 118, 120 of the illustrated example are availability zones. For example, the availability zones can be logical data centers in the subregions 118, 120. The logical data centers can be available for use by an end customer to execute application(s), service(s), workload(s), etc. In some examples, each availability zone in a region can have redundant and separate power, networking, and connectivity to reduce the likelihood of two availability zones failing simultaneously. In the illustrated example, the geographical region 114 is a western region of the European Union and the first and second subregions 118, 120 are respective portions of the western region of the European Union.

The subregions 118, 120 of the illustrated example can include physical servers, or portion(s) thereof, that can be used to execute and/or instantiate example virtual resources 122, 124, 126 (identified by CUSTOMER VIRTUAL MACHINE). The virtual resources 122, 124, 126 of the illustrated example include a first example virtual resource 122, a second example virtual resource 124, and a third example virtual resource 126. The virtual resources 122, 124, 126 are virtual machines (VMs). For example, the virtual resources 122, 124, 126 can be virtualizations of physical hardware resources that can be assembled, compiled, and/or otherwise organized into VMs. Additionally and/or alternatively, one(s) of the virtual resources 122, 124, 126 may be containers.

The private cloud 106 of the illustrated example is an on-premises customer environment associated with an enterprise. For example, enterprises can use Infrastructure-as-a-Service (IaaS) as a business-internal organizational cloud computing platform (sometimes referred to as a “private cloud”) that gives an application developer access to infrastructure resources, such as virtualized servers, storage, and network resources.

The private cloud 106 of the illustrated example includes a first example datacenter 128 (identified by DATACENTER 1 (REGION)), a second example datacenter 130 (identified by DATACENTER 2 (REGION)), and a third example datacenter 132 (identified by DATACENTER 3 (REGION)). In some examples, the datacenters 128, 130, 132 are logical data centers that correspond to respective ones of the cloud providers 108, 110, 112. For example, the first datacenter 128 can be a logical data center that corresponds to a first virtualized environment hosted and/or instantiated by the first cloud provider 108.

The datacenters 128, 130, 132 of the illustrated example can include one or more example clusters 134. In this example, the cluster 134 of the third datacenter 132 (identified by CLUSTER 3.1 (AVAILABILITY ZONE)) can instantiate an availability zone. For example, the cluster 134 of the third datacenter 132 can have redundant and separate power, networking, and connectivity from a different availability zone of the private cloud 106 to reduce the likelihood of two availability zones failing simultaneously. In the illustrated example, the cluster 134 instantiates a fourth example virtual resource 136 (identified by CUSTOMER VIRTUAL MACHINE). The fourth virtual resource 136 of the illustrated example is a VM. Additionally and/or alternatively, the fourth virtual resource 136 may be a container.

In some examples, the datacenters 128, 130, 132 can be managed by server management software, such as vCenter Server by VMware, Inc. For example, the server management software can be executed and/or instantiated by a virtual resource, such as a VM, to design, deploy, and/or maintain a cloud computing deployment, such as one(s) of the virtual resources 122, 124, 126 hosted by one(s) of the cloud providers 108, 110, 112.

In some examples, the server management software can be implemented by the lifecycle management controller 102, which is executed and/or instantiated by the fourth virtual resource 136. For example, the lifecycle management controller 102 can be implemented by hardware, software, and/or firmware that executes and/or instantiates server management software. In some examples, the lifecycle management controller 102 can execute and/or instantiate server management software to enable a user (e.g., a developer, information technology (IT) personnel, etc., of an enterprise that manages the private cloud 106) to manage virtual infrastructure hosted by one(s) of the cloud providers 108, 110, 112 from one or more locations (e.g., one or more centralized locations, satellite or remote locations, etc.). For example, the lifecycle management controller 102 can design, deploy, and/or maintain (e.g., manage) one(s) of the virtual resources 122, 124, 126.

The lifecycle management controller 102 of the illustrated example includes an example adapters host service 138 to interface with the private cloud 106 and/or one(s) of the cloud providers 108, 110, 112 of the public cloud 104. For example, the adapters host service 138 can be implemented by application programming interface(s) (API(s)). The adapters host service 138 of the illustrated example includes a first example adapter 140 (identified by CLOUD PROVIDER A ADAPTER), a second example adapter 142 (identified by CLOUD PROVIDER B ADAPTER), a third example adapter 144 (identified by CLOUD PROVIDER C ADAPTER), and a fourth example adapter 146 (identified by PRIVATE CLOUD ADAPTER). In some examples, the lifecycle management controller 102 can execute and/or instantiate the first adapter 140 to interface with the first cloud provider 108. In some examples, the lifecycle management controller 102 can execute and/or instantiate the second adapter 142 to interface with the second cloud provider 110. In some examples, the lifecycle management controller 102 can execute and/or instantiate the third adapter 144 to interface with the third cloud provider 112. In some examples, the lifecycle management controller 102 can execute and/or instantiate the fourth adapter 146 to interface with the private cloud 106.

The lifecycle management controller 102 of the illustrated example includes an example schedules service 148 to generate schedules (e.g., cloud computing schedules, virtual resource schedules, Day 0 schedules, Day 1 schedules, Day 2 schedules, etc.) that can be used to design, deploy, and/or maintain a virtual resource in a virtualized environment. For example, the schedules service 148 can be executed and/or instantiated periodically or aperiodically to analyze whether an action (e.g., a schedule action) or operation (e.g., a schedule operation) is to be performed or carried out in connection with one(s) of the virtual resources 122, 124, 126.

The lifecycle management controller 102 of the illustrated example includes an example rules service 150 to inspect, analyze, and/or evaluate rule(s) of a schedule to identify one(s) of the virtual resources 122, 124, 126 of which action(s)/operation(s) is/are to be applied. For example, the rules service 150 can be executed and/or instantiated to determine whether a schedule rule applies to one(s) of the virtual resources 122, 124, 126. By way of example, a schedule can include a rule that is applicable to and/or otherwise corresponds to a virtual resource hosted by the first cloud provider 108 that has a compute utilization greater than a 30% threshold. The example rules service 150 can be executed and/or instantiated to identify all or a portion of the virtual resources hosted by the first cloud provider 108. The example rules service 150 can be executed and/or instantiated to obtain utilization data associated with the virtual resources hosted by the first cloud provider 108. The example rules service 150 can be executed and/or instantiated to identify the first virtual resource 122 after a determination that the first virtual resource 122 has a compute utilization of 50%, which is greater than the threshold of 30% and thereby satisfies the threshold. The example rules service 150 can be executed and/or instantiated to determine that one or more actions/operations are to be carried out in connection with the first virtual resource 122 after a determination that the rule applies to the first virtual resource 122. Example actions/operations can include transferring portion(s) of a workload from the first virtual resource 122 to reduce the compute utilization below the threshold, allocating additional virtual resources to the first virtual resource 122 (e.g., instantiating another VM or container, adding an increased quantity of compute resources, etc.), etc., and/or any combination(s) thereof.

The lifecycle management controller 102 of the illustrated example includes an example metrics service 152 to obtain metrics, parameters, etc., representative of virtual resource utilization. In some examples, the metrics service 152 can request a virtual resource to provide utilization data, such as compute utilization data, storage utilization data, network utilization data, etc. For example, the metrics service 152 can determine that the first virtual resource 122 is overutilized based on a determination that a compute utilization of 80% of the first virtual resource 122 is greater than a utilization threshold of 50%. In some examples, the metrics service 152 can determine that the first virtual resource 122 is underutilized based on a determination that a compute utilization of 15% of the first virtual resource 122 is less than a utilization threshold of 40%.

The lifecycle management controller 102 of the illustrated example includes an example provisioning service 154 to configure, instantiate, and/or deploy virtual resources, such as one(s) of the virtual resources 122, 124, 126, in a virtualized environment, such as the public cloud 104. In some examples, the provisioning service 154 can be executed and/or instantiated to commission (e.g., instantiate, startup, power or turn on, allocate, etc.) or decommission (e.g., shutdown, power or turn off, deallocate, etc.) a virtual resource after an evaluation of a rule. For example, the rules service 150 can determine that the first virtual resource 122 is to be upsized by adding virtual resource(s), such as virtualized CPU(s), to the first virtual resource 122.

FIG. 2 is a block diagram of example lifecycle management control (LMC) circuitry 200 to execute and/or otherwise perform schedule-based lifecycle management of virtual resources in a virtualized environment. In some examples, the lifecycle management controller 102 of FIG. 1, and/or, more generally, the fourth virtual resource 136 of FIG. 1, can be implemented by the LMC circuitry 200.

The LMC circuitry 200 of FIG. 2 may be instantiated (e.g., creating an instance of, bring into being for any length of time, materialize, implement, etc.) by processor circuitry such as a central processing unit executing instructions. Additionally or alternatively, the LMC circuitry 200 of FIG. 2 may be instantiated (e.g., creating an instance of, bring into being for any length of time, materialize, implement, etc.) by an ASIC or an FPGA structured to perform operations corresponding to the instructions. It should be understood that some or all of the LMC circuitry 200 of FIG. 2 may, thus, be instantiated at the same or different times. Some or all of the LMC circuitry 200 of FIG. 2 may be instantiated, for example, in one or more threads executing concurrently on hardware and/or in series on hardware. Moreover, in some examples, some or all of the LMC circuitry 200 of FIG. 2 may be implemented by microprocessor circuitry executing instructions to implement one or more virtual machines and/or containers.

The LMC circuitry 200 of the illustrated example of FIG. 2 includes example interface circuitry 210, example schedule generation circuitry 220, example schedule evaluation circuitry 230, example resource identification circuitry 240, example rule evaluation circuitry 250, example operation execution circuitry 260, an example datastore 270, and an example bus 280. In this example, the datastore 270 includes an example schedule 272, example rules 274, example parameters 276, and example snapshots 278. In the illustrated example of FIG. 2, the interface circuitry 210, the schedule generation circuitry 220, the schedule evaluation circuitry 230, the resource identification circuitry 240, the rule evaluation circuitry 250, the operation execution circuitry 260, and/or the datastore 270 are in communication with one(s) of each other via the bus 280. For example, the bus 280 can be implemented by at least one of an Inter-Integrated Circuit (I2C) bus, a Serial Peripheral Interface (SPI) bus, a Peripheral Component Interconnect (PCI) bus, or a Peripheral Component Interconnect Express (PCIe or PCIE) bus. Additionally or alternatively, the bus 280 can be implemented by any other type of computing or electrical bus.

In some examples, the adapters host service 138 of FIG. 1 can be implemented by the interface circuitry 210. In some examples, the schedules service 148 of FIG. 1 can be implemented by the schedule generation circuitry 220 and/or the schedule evaluation circuitry 230. In some examples, the rules service 150 of FIG. 1 can be implemented by the resource identification circuitry 240 and/or the rule evaluation circuitry 250. In some examples, the metrics service 152 of FIG. 1 can be implemented by the interface circuitry 210 and/or the rule evaluation circuitry 250. In some examples, the provisioning service 154 of FIG. 1 can be implemented by the operation execution circuitry 260.

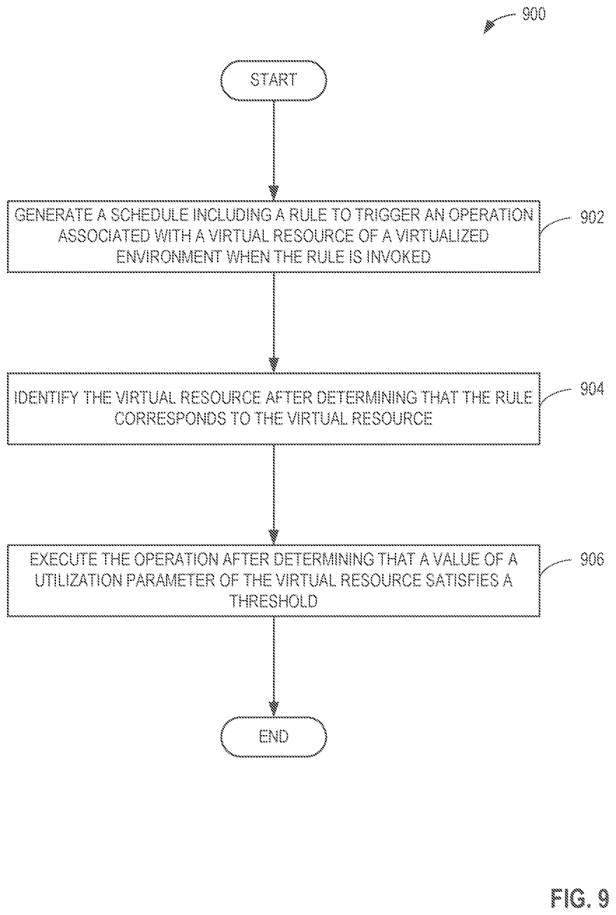

The LMC circuitry 200 of the illustrated example includes the interface circuitry 210 to obtain and/or transmit data. In some examples, the interface circuitry 210 is instantiated by processor circuitry executing interface instructions and/or configured to perform operations such as those represented by the flowcharts of FIGS. 9, 10, 11, 12, and/or 13.

In some examples, the interface circuitry 210 obtains data representative of a request. For example, the request can be a call for a creation of a schedule, which can include schedule data fields for enforcement of a rule, such as one(s) of the rules 274. In some examples, the schedule can be the schedule 272 stored in the datastore 270. By way of example, the interface circuitry 210 can obtain a request from a user via a graphical user interface (GUI) or human machine interface (HMI) of a computing or electronic system. The user can issue the request for the schedule 272 to check (e.g., aperiodically check, periodically check, etc.) whether one or more virtual resources managed by the user are to undergo a specified action or operation. In some examples, the schedule 272 can include the rule 274, which can be a condition, a circumstance, etc., that, when satisfied, triggered, and/or otherwise met, can cause the action/operation to be undertaken in connection with one(s) of the one or more virtual resources.

In some examples, the interface circuitry 210 obtains a request for utilization data for virtual resources of a cloud provider associated with the schedule 272. For example, the interface circuitry 210 can obtain a request for utilization data associated with the first virtual resource 122 hosted by the first cloud provider 108. In some examples, a hypervisor managing the first virtual resource 122, and/or, more generally, the first cloud provider 108, can collect and/or otherwise obtain utilization data associated with the first virtual resource 122. For example, the hypervisor can obtain compute utilization data, memory utilization data, storage utilization data, network utilization data, etc., associated with the first virtual resource 122. The hypervisor, and/or, more generally, the first cloud provider 108, can provide, deliver, and/or otherwise transmit the utilization data to the interface circuitry 210.

In some examples, the interface circuitry 210 obtains utilization data (e.g., utilization parameters such as the parameters 276) associated with a virtual resource. For example, the interface circuitry 210 can obtain utilization data from a virtual resource, such as one(s) of the virtual resources 122, 124, 126 hosted by one(s) of the cloud providers 108, 110, 112. In some examples, the interface circuitry 210 can store the utilization data in the datastore 270 as the parameters 276. In some examples, the interface circuitry 210 can determine that the utilization data includes one or more utilization parameters, such as the parameters 276, associated with one(s) of the virtual resources 122, 124, 126. For example, the interface circuitry 210 can receive utilization data including a compute utilization parameter, a memory utilization parameter, a storage utilization parameter, a network utilization parameter, etc., associated with the first virtual resource 122. For example, the interface circuitry 210 can store the compute utilization parameter, the memory utilization parameter, the storage utilization parameter, and/or the network utilization parameter in the datastore 270 as the parameters 276.

The LMC circuitry 200 of the illustrated example includes the schedule generation circuitry 220 to generate a schedule associated with managing a virtual resource in a virtualized environment. For example, the schedule generation circuitry 220 can generate one or more schedules, such as the schedule 272, to perform lifecycle management of virtual resources as disclosed herein. In some examples, the schedule generation circuitry 220 is instantiated by processor circuitry executing schedule generation instructions and/or configured to perform operations such as those represented by the flowcharts of FIGS. 9, 10, 11, 12, and/or 13.

In some examples, the schedule generation circuitry 220 can generate the schedule 272 to include one or more data fields, which can be referred to herein as schedule data fields. For example, the schedule generation circuitry 220 can configure one of the schedule data fields with a name of a cloud provider (e.g., a name, description, or identifier of one of the cloud providers 108, 110, 112 of FIG. 1) associated with a virtual resource. In some examples, the schedule generation circuitry 220 can configure one of the schedule data fields with a time zone. In some examples, the schedule generation circuitry 220 can configure one of the schedule data fields with a first timestamp at which to start enforcement of the rule 274. In some examples, the schedule generation circuitry 220 can configure one of the schedule data fields with a second timestamp at which to end enforcement of the rule 274. In some examples, the schedule generation circuitry 220 can configure one of the schedule data fields with a project name (e.g., a virtual infrastructure project name, a cloud deployment project name, etc.).

In some examples, the schedule generation circuitry 220 can configure one of the schedule data fields with tags. For example, the tags can be implemented by data, such as metadata, that can associate alphanumerical-based descriptions to the schedule 272. In some examples, the schedule generation circuitry 220 can configure one of the schedule data fields with a type of operation to be executed in response to enforcement of the rule 274. For example, the type of operation can be a power off operation, a power on operation, a downsize operation, an upsize operation, a migration operation (e.g., migrating a workload or application from a first virtual resource to a second virtual resource), a snapshot operation, etc., and/or any combination(s) thereof. In some examples, the schedule generation circuitry 220 can configure one of the schedule data fields with threshold(s) (e.g., utilization threshold(s)) associated with triggering of the rule 274. In some examples, the schedule generation circuitry 220 can configure other one(s) of the schedule data fields with any other data, parameter(s), etc.

In some examples, the schedule generation circuitry 220 generates the schedule 272, which can include a rule, such as one(s) of the rules 274, to trigger an operation associated with a virtual resource of a virtualized environment when the rule is invoked. For example, the schedule generation circuitry 220 can generate the schedule 272 to manage the design, deployment, and/or maintenance of the first virtual resource 122 of FIG. 1. In some examples, the schedule generation circuitry 220 can generate the schedule 272 to include one of the rules 274 that, when invoked or triggered, can cause an operation to be executed in connection with the first virtual resource 122. For example, the one of the rules 274 can be to add compute resources to the first virtual machine 122 if a compute utilization of the first virtual machine 122 satisfies a compute utilization threshold (e.g., a compute utilization of 85% of the first virtual machine 122 is greater than a compute utilization of 60% specified by the one of the rules 274).

In some examples, after the schedule 272 has been inspected, analyzed, and/or otherwise evaluated, the schedule generation circuitry 220 can update the schedule 272 based on a last run time (e.g., a time at which the schedule 272 was last inspected, analyzed, evaluated, etc.) and/or status. For example, the status can include a result of the schedule evaluation, such as whether an action/operation is to be performed, which rule(s) is/are invoked, which virtual resource(s) is/are affected, etc., and/or any combination(s) thereof.

In some examples, the schedule generation circuitry 220 can generate the schedule 272 to include one or more cron expressions. For example, the schedule 272 can be implemented by a cron schedule, a cron job schedule, etc. As used herein, a cron expression is a string data format (e.g., a unix-cron string format), which can include one or more fields in a line. In some examples, a cron expression can be implemented by a string format of (* . . . *) where each “*” represents a data field. Alternatively, the cron expression may have any number of data fields. In some examples, the schedule generation circuitry 220 can generate the schedule 272 to include a cron expression that has 5 data fields, which can be represented by a cron expression of (* * * * *). For example, the first data field can be a data value representative of a minute in a range of 0-59, the second data field can be a data value representative of an hour in a range of 0-23, the third data field can be a data value representative of a day of the month in a range of 1-31, the fourth data field can be a data value representative of a month in a range of 1-12 (or JANUARY to DECEMBER), and the fifth data field can be a data value representative of a day of the week in a range of 0-6 (or SUNDAY to SATURDAY). In some examples, the schedule generation circuitry 220 can generate the schedule 272 to include the cron expression with the first through fifth data fields to represent when the schedule 272 is to be evaluated.

The LMC circuitry 200 of the illustrated example includes the schedule evaluation circuitry 230 to evaluate a schedule, such as the schedule 272, to determine whether rule(s) is/are triggered. In some examples, the schedule evaluation circuitry 230 is instantiated by processor circuitry executing schedule evaluation instructions and/or configured to perform operations such as those represented by the flowcharts of FIGS. 9, 10, 11, 12, and/or 13.

In some examples, the schedule evaluation circuitry 230 determines whether it is time to check the schedule 272. For example, the schedule evaluation circuitry 230 can determine whether a timer associated with the schedule 272 has elapsed, expired, etc., to check the schedule. In some examples, the schedule evaluation circuitry 230 selects a schedule of interest to process. For example, assume that the private cloud 106 manages 15 schedules associated with the first cloud provider 108, 20 schedules associated with the second cloud provider 110, and 30 schedules associated with the third cloud provider 112. In some examples, the schedule evaluation circuitry 230 can select a first one of the 15 schedules associated with the first cloud provider 108 to evaluate. In some examples, the schedule evaluation circuitry 230 can select another schedule of interest to process, such as a second one of the 15 schedules or a first one of the 20 schedules associated with the second cloud provider 110. In some examples, the schedule evaluation circuitry 230 determines whether to monitor (e.g., continue to monitor, iteratively monitor, etc.) a virtual resource based on a schedule associated with the virtual resource.

The LMC circuitry 200 of the illustrated example includes the resource identification circuitry 240 to identify a virtual resource. In some examples, the resource identification circuitry 240 is instantiated by processor circuitry executing resource identification instructions and/or configured to perform operations such as those represented by the flowcharts of FIGS. 9, 10, 11, 12, and/or 13.

In some examples, the resource identification circuitry 240 can identify that one(s) of virtual resources correspond to a schedule, such as the schedule 272. For example, the resource identification circuitry 240 can determine that the schedule 272 includes a rule, such as one of the rules 274, that is applicable to at least one of the first virtual resource 122, the second virtual resource 124, or the third virtual resource 126 of FIG. 1. For example, the resource identification circuitry 240 can identify the first virtual resource 122 of FIG. 1 after determining that a rule corresponds to the virtual resource 122.

In some examples, the resource identification circuitry 240 can identify a virtual resource corresponding to a cloud provider. For example, the resource identification circuitry 240 can determine that the schedule 272 includes a schedule data field that identifies the first cloud provider 108. In some examples, the resource identification circuitry 240 can identify virtual resources hosted by the first cloud provider 108, such as the first virtual resource 122, that correspond to the first cloud provider 108. In some examples, the resource identification circuitry 240 can identify the virtual resources as corresponding to the schedule 272 and/or the first cloud provider 108 based on a determination that the schedule data field of the schedule 272 identifies the first cloud provider 108.

The LMC circuitry 200 of the illustrated example includes the rule evaluation circuitry 250 to evaluate whether a schedule rule, such as one of the rules 274, is to be triggered and/or otherwise invoked. In some examples, the rule evaluation circuitry 250 is instantiated by processor circuitry executing rule evaluation instructions and/or configured to perform operations such as those represented by the flowcharts of FIGS. 9, 10, 11, 12, and/or 13.

In some examples, the rule evaluation circuitry 250 identifies one(s) of virtual resources whose utilization data satisfies utilization threshold(s). For example, the rule evaluation circuitry 250 can select a virtual resource, such as the first virtual resource 122 of FIG. 1, to process. In some examples, the rule evaluation circuitry 250 can select a different virtual resource to process, such as the second virtual resource 124 of FIG. 1. In some examples, the rule evaluation circuitry 250 can select the different virtual resource in sequence or in parallel (e.g., substantially in parallel) with selection of the first virtual resource 122.

In some examples, the rule evaluation circuitry 250 can determine that the first utilization resource 122 has a compute utilization of 40% and a storage utilization of 85%. For example, the rule evaluation circuitry 250 can determine whether the first virtual resource 122 has a utilization parameter that satisfies a threshold specified by a schedule rule, such as one of the rules 274. In some examples, the rule evaluation circuitry 250 can determine that the compute utilization of 40% is below a compute utilization threshold of 50% and thereby determine that the first virtual resource 122 is underutilized with respect to compute utilization. In some examples, the rule evaluation circuitry 250 can determine that the storage utilization of 85% is above a storage utilization threshold of 70% and thereby determine that the first virtual resource 122 is overutilized with respect to storage utilization.

In some examples, the rule evaluation circuitry 250 can determine whether to create a snapshot of a virtual source based on a schedule rule. For example, the rule evaluation circuitry 250 can determine that the schedule 272 includes a rule that, when triggered, can cause a snapshot of an applicable virtual resource to be captured. In some examples, the snapshot can be a backup of a virtual resource, such as storing a copy of the virtual resource, or portion(s) thereof. For example, the backup can be used to recover the virtual resource if the virtual resource has failed. In some examples, the backup of a first virtual resource can be used to failover the first virtual resource to a second virtual resource if the first virtual resource is executing a high availability application or workload. In some examples, the rule evaluation circuitry 250 can cause the snapshot to be stored in the datastore 270 as one(s) of the snapshots 278.

The LMC circuitry 200 of the illustrated example includes the operation execution circuitry 260 to execute an operation associated with a virtual resource based on a schedule rule, such as one of the rules 274. In some examples, the operation execution circuitry 260 is instantiated by processor circuitry executing operation execution instructions and/or configured to perform operations such as those represented by the flowcharts of FIGS. 9, 10, 11, 12, and/or 13.

In some examples, the operation execution circuitry 260 executes an operation after a determination that a value of a utilization parameter of a virtual resource satisfies a threshold. For example, the operation execution circuitry 260 can execute an operation on the first virtual resource 122 after a determination that the first virtual resource 122 has a compute utilization of 10% that is less than a compute utilization threshold of 40%.

In some examples, the operation execution circuitry 260 can execute an action (e.g., a schedule action) or operation (e.g., a schedule operation) such as a resize operation. For example, the operation execution circuitry 260 can resize the first virtual resource 122 by upsizing the first virtual resource 122 or downsizing the first virtual resource 122. In some examples, the operation execution circuitry 260 can upsize the first virtual resource 122 by adding resources (e.g., compute, network or networking, storage, etc., resources) to the first virtual resource 122. In some examples, the operation execution circuitry 260 can downsize the first virtual resource 122 by removing resources (e.g., compute, network or networking, storage, etc., resources) from the first virtual resource 122.

In some examples, the operation execution circuitry 260 can execute an action (e.g., a schedule action) or operation (e.g., a schedule operation) such as a power on or off operation. For example, the operation execution circuitry 260 can power off the first virtual resource 122 in response to a determination that the first virtual resource 122 invoked a rule, such as one of the rules 274, that specifies a virtual resource to be powered off if the rule is triggered. In some examples, the operation execution circuitry 260 can power on the first virtual resource 122 in response to a determination that the first virtual resource 122 invoked a rule that specifies a virtual resource to be powered on if the rule is triggered.

In some examples, the operation execution circuitry 260 can execute an action (e.g., a schedule action) or operation (e.g., a schedule operation) such as a snapshot operation. For example, the operation execution circuitry 260 can create snapshots of the first virtual resource 122 to achieve improved failure recovery of the first virtual resource 122 or backup recovery features associated with the first virtual resource 122. In some examples, the operation execution circuitry 260 can store the snapshots in the datastore 270 as the snapshots 278. In some examples, the operation execution circuitry 260 can execute the snapshot operation by storing at least one of configuration data or workload data associated with the first virtual resource 122 in the datastore 270 as the snapshots 278 or as any other data.

In some examples, the configuration data can include a type of the first virtual resource 122, such as a VM, a container, a switch (e.g., a network switch), a gateway (e.g., a network gateway), a router (e.g., a network router), a load balancer, etc. In some examples, the configuration data can include a type and/or version of operating system (OS) installed on the first virtual resource 122. In some examples, the configuration data can include network configuration data, such as an Internet Protocol (IP) address, an IP port, a media access control (MAC) address, etc., of the first virtual resource 122. In some examples, the configuration data can be data representative of an availability parameter, a performance parameter, a capacity parameter, a utilization parameter, etc., associated with the first virtual resource 122. For example, the configuration data can include a number of CPU GHz, a number of RAM GB, a number of mass storage GB, etc., associated with the first virtual resource 122.

In some examples, the workload data can include a type of a workload, such as a machine learning workload, a data routing workload, a computationally-intensive workload, a vector processing workload, etc. In some examples, the workload data can include a description of a workload, such as a name and/or type of application or service being executed. In some examples, the workload data can include a progress of a workload, such as data representative of what portion(s) of the workload is/are complete and/or what portion(s) of the workload is/are to be processed or completed.

In some examples, the operation execution circuitry 260 can execute an action (e.g., a schedule action) or operation (e.g., a schedule operation) such as a migration operation. For example, the operation execution circuitry 260 can assign the first virtual resource 122 from a first workload domain to a second workload domain based on a determination that the first virtual resource 122 is underutilized and/or the second workload domain needs additional resources. In some examples, the operation execution circuitry 260 can migrate and/or otherwise cause a transfer of a workload, or portion(s) thereof, from the first virtual resource 122 to a different virtual resource hosted by the first cloud provider 108. In some examples, the operation execution circuitry 260 can migrate and/or otherwise cause a transfer of a workload, or portion(s) thereof, from the first virtual resource 122 to a different virtual resource hosted by a different cloud provider, such as the second virtual resource 124 hosted by the second cloud provider 110.

The LMC circuitry 200 of the illustrated example includes the datastore 270 to record data. In some examples, the datastore 270 is instantiated by processor circuitry executing datastore instructions and/or configured to perform operations such as those represented by the flowcharts of FIGS. 9, 10, 11, 12, and/or 13. In the illustrated example, the datastore 270 records the schedule 272, the rules 274, the parameters 276, and the snapshots 278. The datastore 270 may be implemented by a volatile memory (e.g., a Synchronous Dynamic Random Access Memory (SDRAM), Dynamic Random Access Memory (DRAM), RAMBUS Dynamic Random Access Memory (RDRAM), etc.) and/or a non-volatile memory (e.g., flash memory). The example datastore 270 may additionally or alternatively be implemented by one or more double data rate (DDR) memories, such as DDR, DDR2, DDR3, DDR4, mobile DDR (mDDR), etc. The example datastore 270 may additionally or alternatively be implemented by one or more mass storage devices such as HDD(s), SSD(s), compact disk (CD) drive(s), digital versatile disk (DVD) drive(s), etc. While in the illustrated example the datastore 270 is illustrated as a single datastore, the datastore 270 may be implemented by any number and/or type(s) of datastores. Furthermore, the data stored in the datastore 270 may be in any data format such as, for example, binary data, comma delimited data, tab delimited data, structured query language (SQL) structures, numerical values, string data, etc.

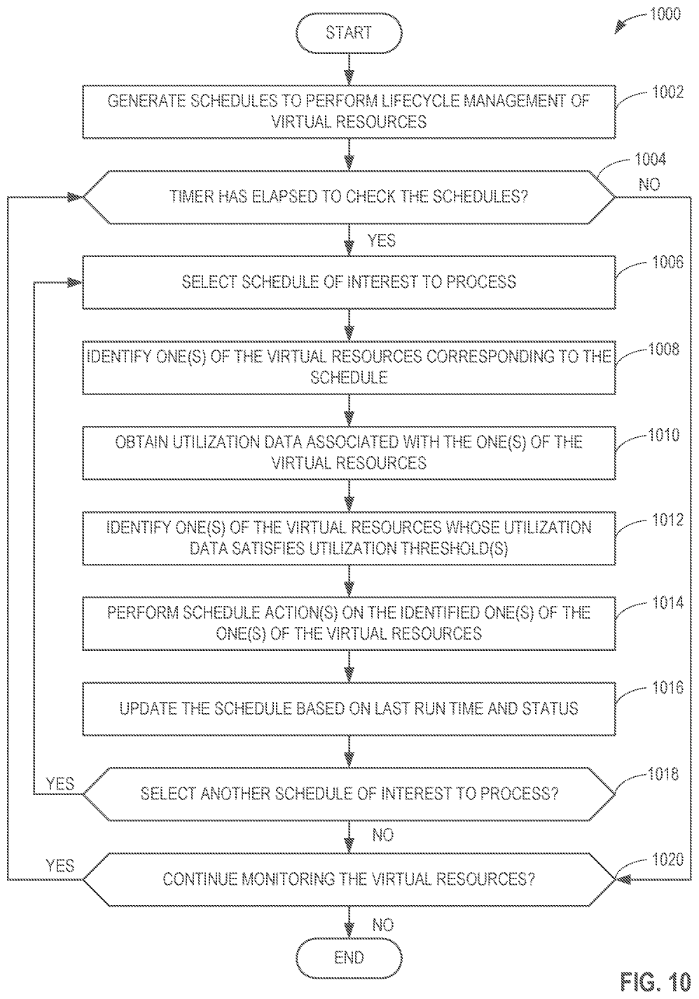

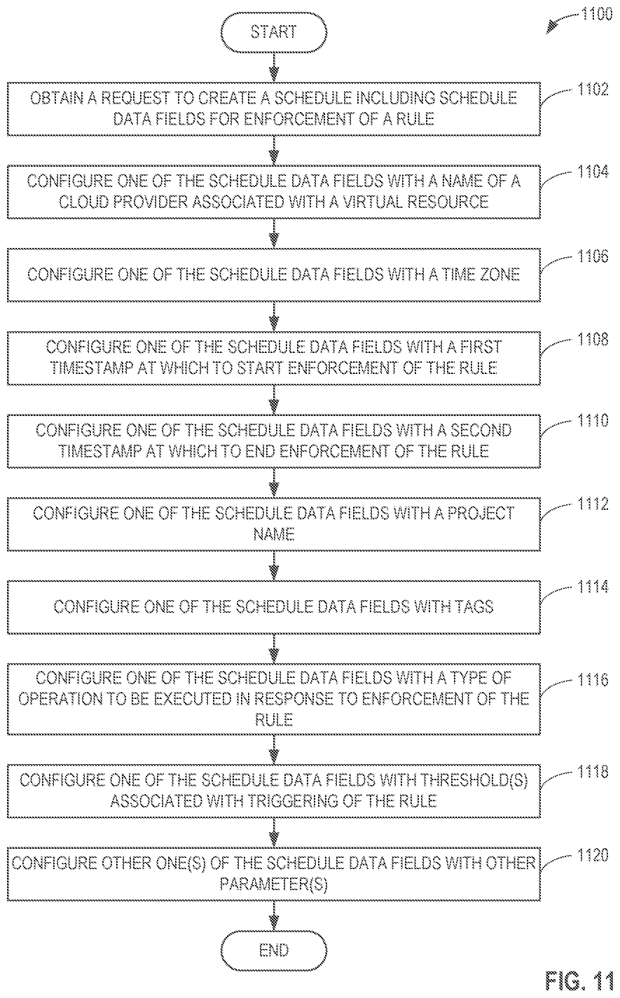

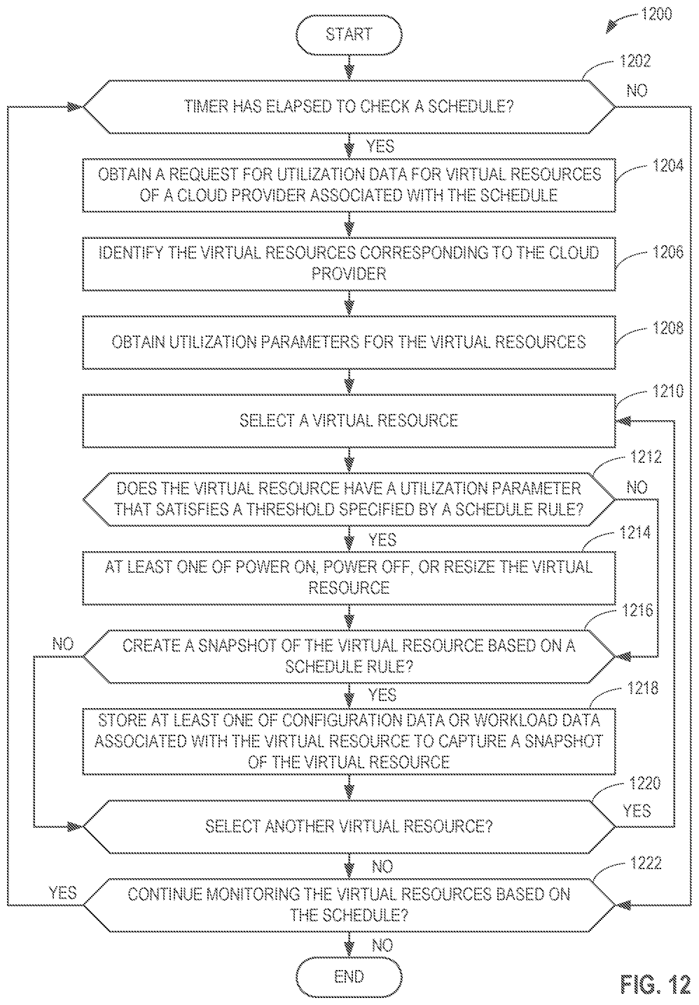

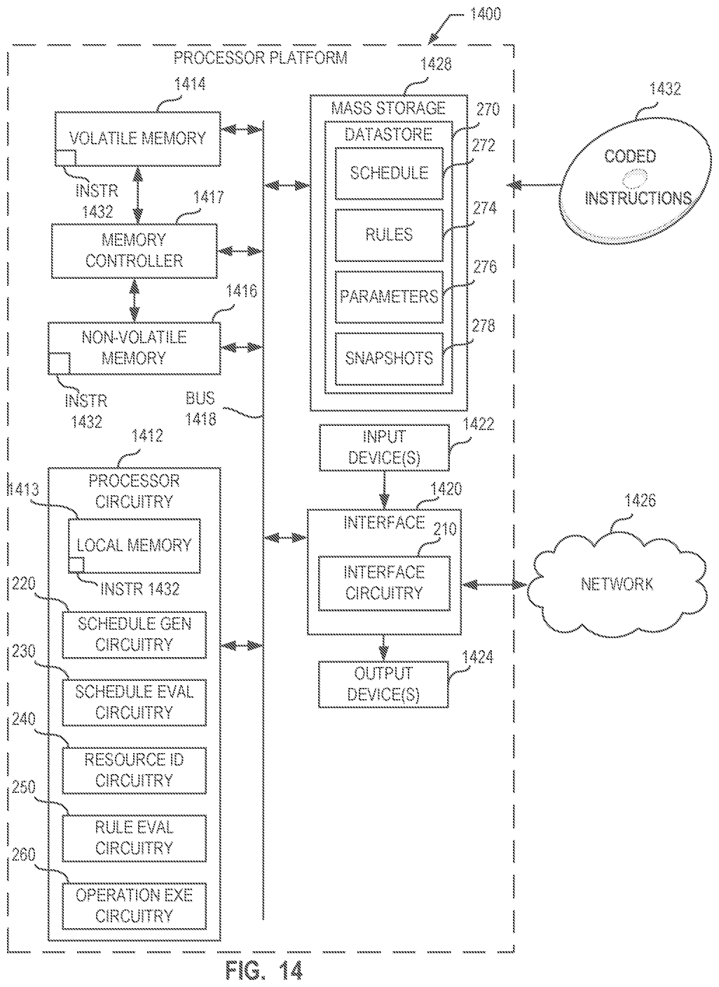

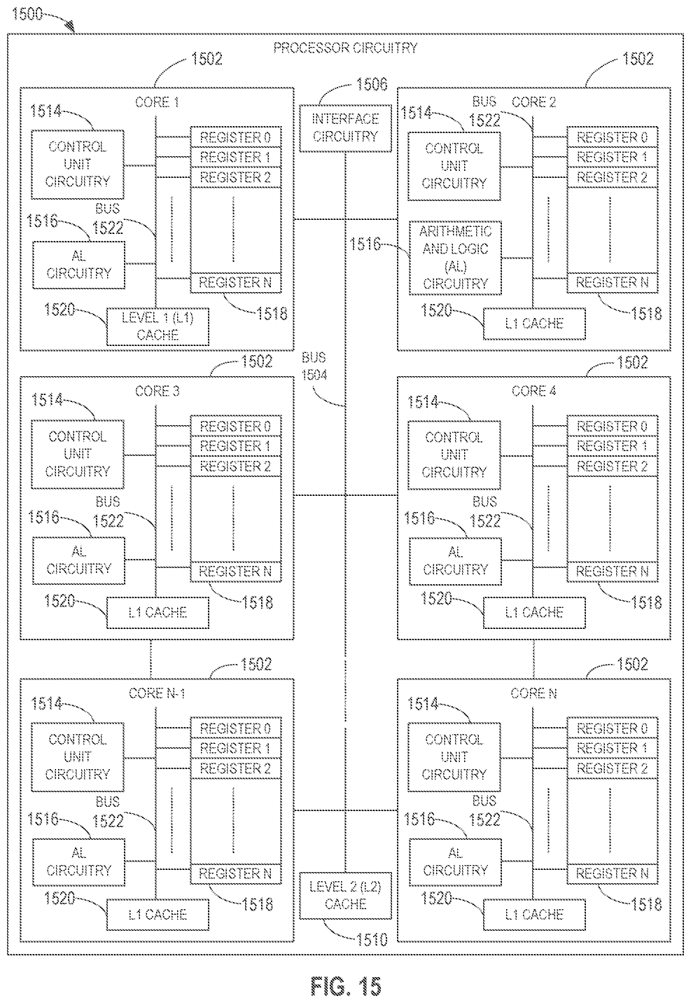

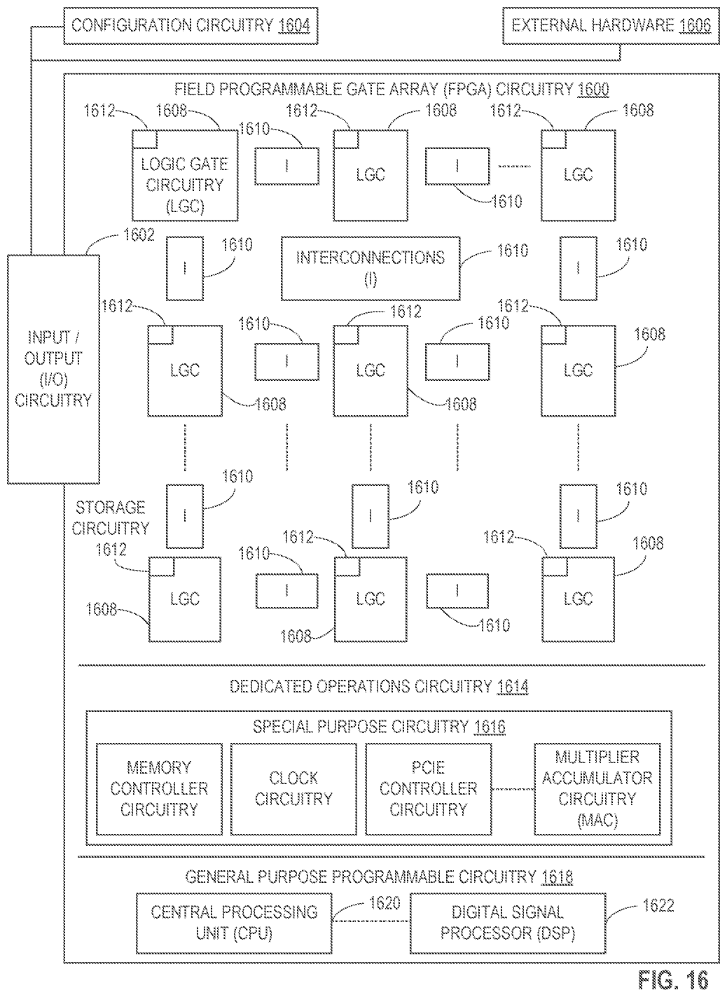

In some examples, the LMC circuitry 200 includes means for obtaining data. For example, the means for obtaining can obtain configuration data, workload data, utilization data, etc. For example, the means for obtaining may be implemented by the interface circuitry 210. In some examples, the interface circuitry 210 may be instantiated by processor circuitry such as the example processor circuitry 1412 of FIG. 14. For instance, the interface circuitry 210 may be instantiated by the example microprocessor 1500 of FIG. 15 executing machine executable instructions such as those implemented by at least block 1010 of FIG. 10, block 1102 of FIG. 11, and/or blocks 1204, 1208 of FIG. 12. In some examples, the interface circuitry 210 may be instantiated by hardware logic circuitry, which may be implemented by an ASIC, XPU, or the FPGA circuitry 1600 of FIG. 16 structured to perform operations corresponding to the machine readable instructions. Additionally or alternatively, the interface circuitry 210 may be instantiated by any other combination of hardware, software, and/or firmware. For example, the interface circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the LMC circuitry 200 includes means for generating a schedule. For example, the means for generating may be implemented by the schedule generation circuitry 220. In some examples, the schedule generation circuitry 220 may be instantiated by processor circuitry such as the example processor circuitry 1412 of FIG. 14. For instance, the schedule generation circuitry 220 may be instantiated by the example microprocessor 1500 of FIG. 15 executing machine executable instructions such as those implemented by at least block 902 of FIG. 9, block 1004 of FIG. and/or blocks 1104, 1106, 1108, 1110, 1112, 1114, 1116, 1118, 1120 of FIG. 11. In some examples, the schedule generation circuitry 220 may be instantiated by hardware logic circuitry, which may be implemented by an ASIC, XPU, or the FPGA circuitry 1600 of FIG. 16 structured to perform operations corresponding to the machine readable instructions. Additionally or alternatively, the schedule generation circuitry 220 may be instantiated by any other combination of hardware, software, and/or firmware. For example, the schedule generation circuitry 220 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the LMC circuitry 200 includes means for evaluating a schedule. For example, the means for evaluating a schedule may be implemented by the schedule evaluation circuitry 230. In some examples, the schedule evaluation circuitry 230 may be instantiated by processor circuitry such as the example processor circuitry 1412 of FIG. 14. For instance, the schedule evaluation circuitry 230 may be instantiated by the example microprocessor 1500 of FIG. 15 executing machine executable instructions such as those implemented by at least blocks 1006, 1016, 1018, 1020 of FIG. 10 and/or blocks 1202, 1222 of FIG. 12. In some examples, the schedule evaluation circuitry 230 may be instantiated by hardware logic circuitry, which may be implemented by an ASIC, XPU, or the FPGA circuitry 1600 of FIG. 16 structured to perform operations corresponding to the machine readable instructions. Additionally or alternatively, the schedule evaluation circuitry 230 may be instantiated by any other combination of hardware, software, and/or firmware. For example, the schedule evaluation circuitry 230 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the LMC circuitry 200 includes means for identifying a resource (e.g., a virtual resource). For example, the means for identifying may be implemented by the resource identification circuitry 240. In some examples, the resource identification circuitry 240 may be instantiated by processor circuitry such as the example processor circuitry 1412 of FIG. 14. For instance, the resource identification circuitry 240 may be instantiated by the example microprocessor 1500 of FIG. 15 executing machine executable instructions such as those implemented by at least block 904 of FIG. 9, block 1008 of FIG. 10, and/or block 1206 of FIG. 12. In some examples, the resource identification circuitry 240 may be instantiated by hardware logic circuitry, which may be implemented by an ASIC, XPU, or the FPGA circuitry 1600 of FIG. 16 structured to perform operations corresponding to the machine readable instructions. Additionally or alternatively, the resource identification circuitry 240 may be instantiated by any other combination of hardware, software, and/or firmware. For example, the resource identification circuitry 240 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

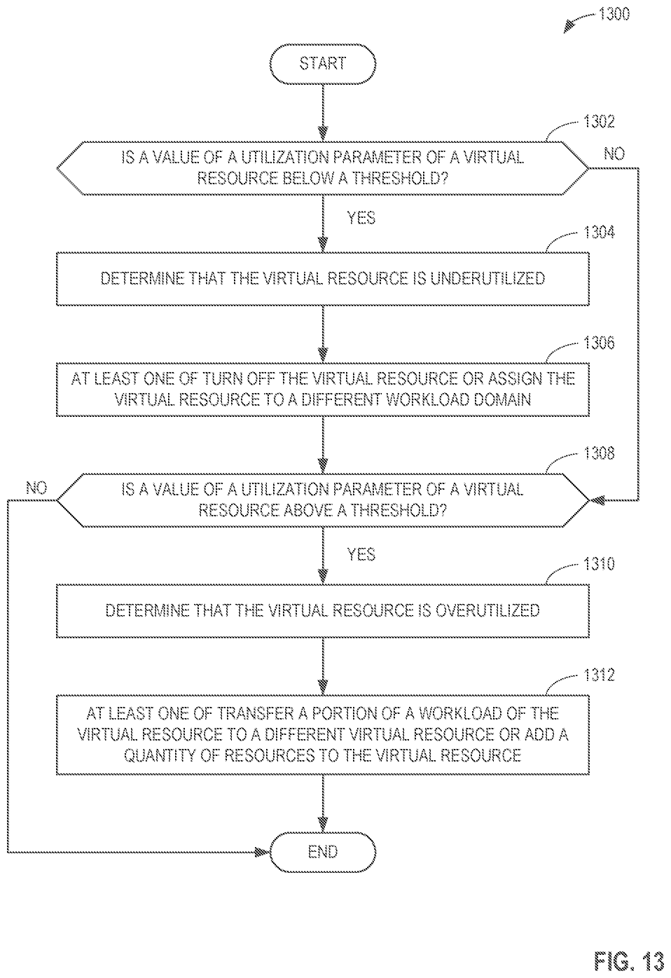

In some examples, the LMC circuitry 200 includes means for evaluating a rule. For example, the means for evaluating a rule may be implemented by the rule evaluation circuitry 250. In some examples, the rule evaluation circuitry 250 may be instantiated by processor circuitry such as the example processor circuitry 1412 of FIG. 14. For instance, the rule evaluation circuitry 250 may be instantiated by the example microprocessor 1500 of FIG. 15 executing machine executable instructions such as those implemented by at least block 1012 of FIG. 10, blocks 1210, 1212, 1216, 1218 of FIG. 12, and/or blocks 1302, 1304, 1308, 1310 of FIG. 13. In some examples, the rule evaluation circuitry 250 may be instantiated by hardware logic circuitry, which may be implemented by an ASIC, XPU, or the FPGA circuitry 1600 of FIG. 16 structured to perform operations corresponding to the machine readable instructions. Additionally or alternatively, the rule evaluation circuitry 250 may be instantiated by any other combination of hardware, software, and/or firmware. For example, the rule evaluation circuitry 250 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the LMC circuitry 200 includes means for executing an action or operation. For example, the means for executing an action or operation may be implemented by the operation execution circuitry 260. In some examples, the operation execution circuitry 260 may be instantiated by processor circuitry such as the example processor circuitry 1412 of FIG. 14. For instance, the operation execution circuitry 260 may be instantiated by the example microprocessor 1500 of FIG. 15 executing machine executable instructions such as those implemented by at least block 906 of FIG. 9, block 1014 of FIG. 10, blocks 1214, 1218 of FIG. 12, and/or blocks 1306, 1312 of FIG. 13. In some examples, the operation execution circuitry 260 may be instantiated by hardware logic circuitry, which may be implemented by an ASIC, XPU, or the FPGA circuitry 1600 of FIG. 16 structured to perform operations corresponding to the machine readable instructions. Additionally or alternatively, the operation execution circuitry 260 may be instantiated by any other combination of hardware, software, and/or firmware. For example, the operation execution circuitry 260 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the LMC circuitry 200 includes means for storing data. For example, the means for storing data may be implemented by the datastore 270. In some examples, the datastore 270 may be instantiated by processor circuitry such as the example processor circuitry 1412 of FIG. 14 and/or one or more mass storage devices such as the one or more mass storage devices 1428 of FIG. 14. For instance, the datastore 270 may be instantiated by the example microprocessor 1500 of FIG. 15 executing machine executable instructions such as those implemented by at least block 1218 of FIG. 12. In some examples, the datastore 270 may be instantiated by hardware logic circuitry, which may be implemented by an ASIC, XPU, or the FPGA circuitry 1600 of FIG. 16 structured to perform operations corresponding to the machine readable instructions. Additionally or alternatively, the datastore 270 may be instantiated by any other combination of hardware, software, and/or firmware. For example, the datastore 270 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the lifecycle management controller 102 of FIG. 1 is illustrated in FIG. 2, one or more of the elements, processes, and/or devices illustrated in FIG. 2 may be combined, divided, re-arranged, omitted, eliminated, and/or implemented in any other way. Further, the interface circuitry 210, the schedule generation circuitry 220, the schedule evaluation circuitry 230, the resource identification circuitry 240, the rule evaluation circuitry 250, the operation execution circuitry 260, the datastore 270, the bus 280, and/or, more generally, the example lifecycle management controller 102 of FIG. 1, may be implemented by hardware alone or by hardware in combination with software and/or firmware. Thus, for example, any of the interface circuitry 210, the schedule generation circuitry 220, the schedule evaluation circuitry 230, the resource identification circuitry 240, the rule evaluation circuitry 250, the operation execution circuitry 260, the datastore 270, the bus 280, and/or, more generally, the example lifecycle management controller 102 of FIG. 1, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example lifecycle management controller 102 of FIG. 1 may include one or more elements, processes, and/or devices in addition to, or instead of, those illustrated in FIG. 2, and/or may include more than one of any or all of the illustrated elements, processes and devices.

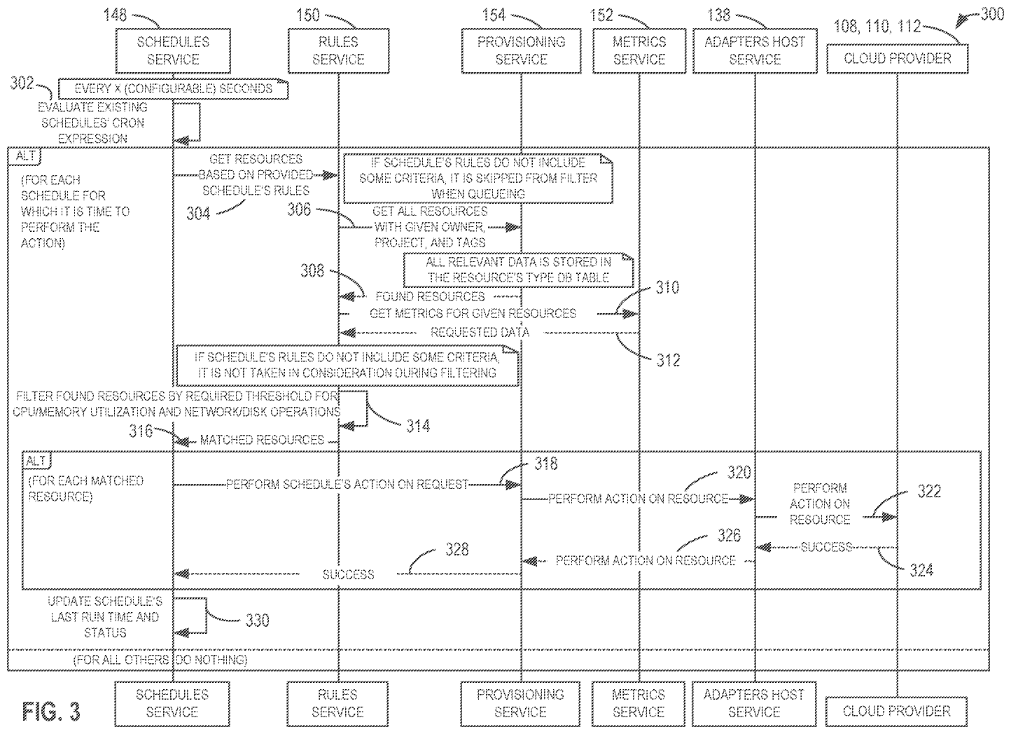

FIG. 3 is a first example workflow 300 to effectuate schedule-based lifecycle management. For example, the first workflow 300 can be executed and/or instantiated by processor circuitry to execute a schedule action/operation based on an evaluation of one or more rules of a schedule. The first example workflow 300 includes the schedules service 148, the rules service 150, the provisioning service 154, the metrics service 152, the adapters host service 138, and the cloud providers 108, 110, 112 of FIG. 1. In example operation, the schedules service 148 can execute the first workflow 300 periodically (e.g., every X number of seconds where X can be configurable). During a first example operation 302, the schedules service 148 can evaluate a cron expression for a schedule, such as the schedule 272 of FIG. 2.

In the first workflow 300, example operations 304, 306, 308, 310, 312, 314, 316 are to be executed for each schedule for which it is time to perform an action. For example, the schedules service 148 can check every 5 seconds whether the cron expression in the schedule 272 indicates that the schedule 272 is to be evaluated. In some examples, the schedules service 148 can determine that a timestamp represented by the cron expression has been met or surpassed since the last time the schedule 272 has been checked.

During a second example operation 304, the schedules service 148 gets resources (e.g., virtual resources) based on the provided schedule's rules 274. During a third example operation 306, the rules service 150 gets all resources with a given owner, project, and tags specified by the rules 274 of the schedule 272. In some examples, if the rules 274 of the schedule 272 do not include specified criteria, such as the owner, project, tags, etc., then one(s) of the rules 274 is/are bypassed from evaluation.

During a fourth example operation 308, the provisioning service 154 returns found resources. In some examples, the datastore 270 can store relevant data to the requested resources. During a fifth example operation 310, the rules service 150 can obtain metrics (e.g., values of compute utilization parameters, storage utilization parameters, etc.), such as the parameters 276, for the given resources. During a sixth example operation 312, the metrics service 152 returns the requested data. During a seventh example operation 314, the rules service 150 can filter and/or otherwise identify one(s) of the found resources based on the requested data. For example, the rules service 150 can identify the first virtual resource 122 of FIG. 1 based on a determination that a CPU utilization of the first virtual resource 122 exceeds a CPU utilization threshold. During an eighth example operation 316, the rules service 150 returns matched resource(s) to the schedules service 148.

In the first workflow 300, example operations 318, 320, 322, 324, 326, 328 are to be executed for each matched resource. During a ninth example operation 318, the schedules service 148 causes one or more schedule actions, operations, etc., to be performed on the resource. For example, the schedule 272 can include a schedule action of turning off a matched virtual resource if the matched virtual resource has a compute utilization that falls beneath a compute utilization threshold. During a tenth example operation 320, the provisioning service 154 causes the action to be performed on the resource. During an eleventh example operation 322, the adapters host service 138 causes the action to be performed on the resource. For example, the first adapter 140 can instruct the first cloud provider 108 to carry out the schedule action on the first virtual resource 122. During a twelfth example operation 324, the cloud providers 108, 110, 112 transmit an acknowledgment that the schedule action is successful to the adapters host service 138. During a thirteenth example operation 326, the adapters host service 138 transmits the acknowledgment to the provisioning service 154. During a fourteenth example operation 328, the provisioning service 154 transmits the acknowledgment to the schedules service 148. During a fifteenth example operation 330, the schedules service 148 can update the schedule with a last run time and/or status (e.g., a status of success based on the received acknowledgement).

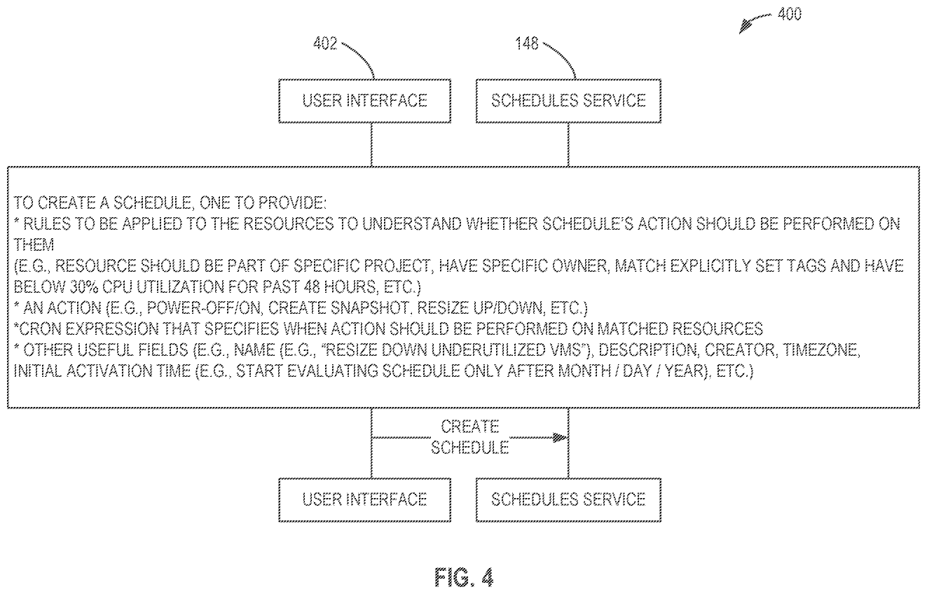

FIG. 4 is a second example workflow 400 to effectuate schedule-based lifecycle management. For example, the second workflow 400 can be executed and/or instantiated by processor circuitry to generate a schedule, such as the schedule 272 of FIG. 2. The second workflow 400 includes an example user interface 402 and the schedules service 148 of FIG. 1. In some examples, the user interface 402 can be implemented by the lifecycle management controller 102, and/or, more generally, the fourth virtual resource 136, of FIG. 1.

During a first example operation 404 of the second workflow 400, the user interface 402 causes a creation of a schedule via the schedules service 148. For example, a user can interact with the user interface 402 to create a schedule, such as the schedule 272 of FIG. 2. In example operation, the user interface 402 can be utilized to create the schedule 272 by providing rules that should be applied to resources to understand whether a schedule's action is to be performed. In example operation, the user interface 402 can be utilized to create the schedule 272 by providing an action, such as a power off or on action, a snapshot action, a resize action, etc. In example operation, the user interface 402 can be utilized to create the schedule 272 by providing a cron expression that specifies when an action should be performed on matched or identified resources. Additionally and/or alternatively, any other type of data expression may be utilized. In example operation, the user interface 402 can be utilized to create the schedule 272 by providing other useful fields, such as a name, a description, a creator (e.g., the user interacting with the user interface 402), a time zone, an initial activation time or timestamp, etc.

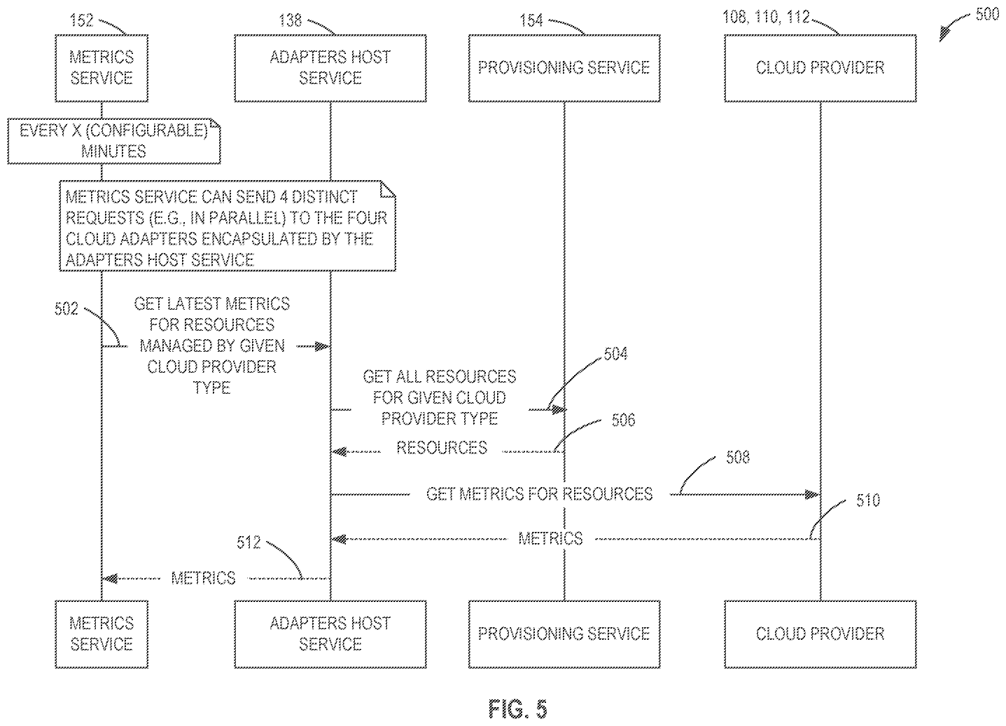

FIG. 5 is a third example workflow 500 to effectuate schedule-based lifecycle management. For example, the third workflow 500 can be executed and/or instantiated by processor circuitry to obtain metrics, such as the parameters 276 of FIG. 2, from virtual resources of interest in a virtualized environment. The third workflow 500 includes the metrics service 152, the adapters host service 138, the provisioning service 154, and the cloud providers 108, 110, 112 of FIG. 1.

During a first example operation 502 of the third workflow 500, the metrics service 152 can periodically (e.g., every X number of minutes where X can be configurable) send requests to one(s) of the cloud providers 108, 110, 112 and/or the private cloud 106 for metrics associated with one(s) of the virtual resources 122, 124, 126, 136. For example, the metrics service 152 can send 4 distinct requests (in parallel) to the adapters 140, 142, 144, 146 encapsulated by the adapters host service 138. During the first operation 502, the metrics service 152 can initiate the obtaining of the latest metrics for resources managed by a given one of the cloud providers 108, 110, 112 and/or the private cloud 106.

During a second example operation 504, the adapters host service 138 can obtain and/or otherwise identify the resources (e.g., the virtual resources 122, 124, 126, 136) for a given cloud provider type (e.g., the first cloud provider 108, the second cloud provider 110, the third cloud provider 112, the private cloud 106, etc.). During a third example operation 506, the provisioning service 154 can return identification(s) of the resources. For example, the provisioning service 154 can provide to the adapters host service 138 an identification of the first virtual resource 122 as being associated with the first cloud provider 108.

During a fourth example operation 508, the adapters host service 138 can request the metrics for the resources identified by the provisioning service 154. During a fifth example operation 510, the cloud providers 108, 110, 112 can return and/or otherwise output the metrics to the adapters host service 138. For example, the adapters host service 138 can request the parameters 276 associated with all or some of the virtual resources hosted by the first cloud provider 108. In some examples, the first cloud provider 108 can provide the parameters 276 associated with all or some of the requested virtual resources, such as the first virtual resource 122. During a sixth example operation 512, the adapters host service 138 can provide the metrics to the metrics service 152, which can present them to a user of the private cloud 106, the rules service 150 for evaluation, etc., and/or any combination(s) thereof.

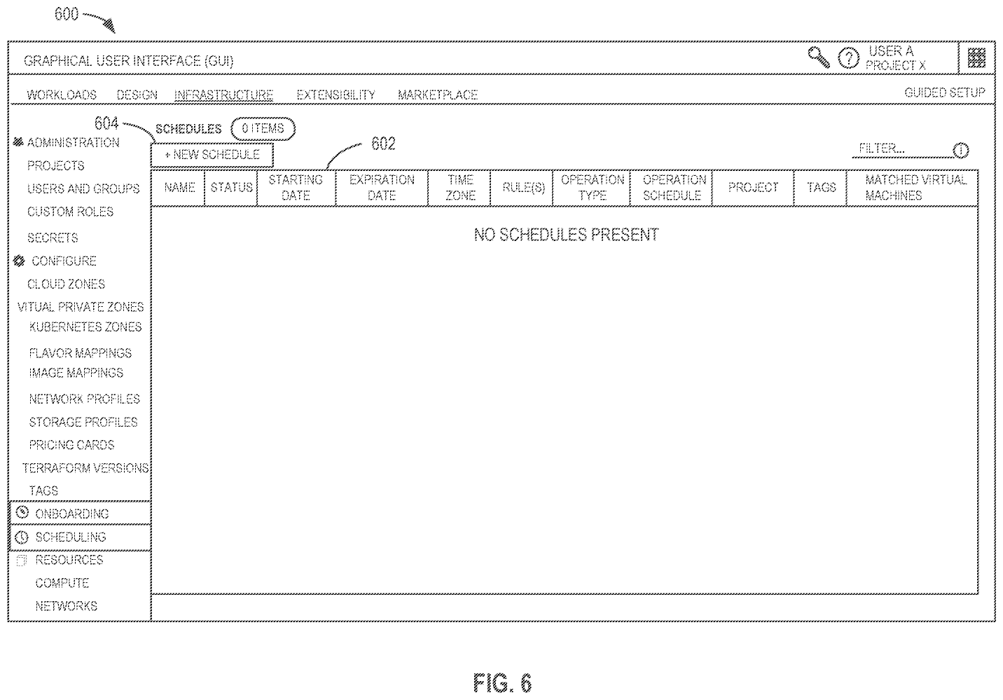

FIG. 6 is a first example graphical user interface (GUI) 600 to create an example schedule, such as the schedule 272 of FIG. 2. In some examples, the user interface 402 of FIG. 4 can be implemented by the first GUI 600. The first GUI 600 is a schedule GUI or a schedule generation GUI that can be accessed and/or otherwise interacted with to generate a schedule, such as the schedule 272 of FIG. 2. The first GUI 600 of the illustrated example includes example schedule data fields 602, such as a name data field, a status data field, a starting date data field, an expiration date data field, a time zone data field, a rule(s) data field, an operation type data field, an operation schedule data field, a project (or project name/description) data field, a tags data field, and a matched virtual machines data field. Additionally and/or alternatively, the first GUI 600 may include fewer or more schedule data fields than those depicted in the illustrated example of FIG. 6. A user can create a new schedule by selecting an example new schedule GUI button 604.

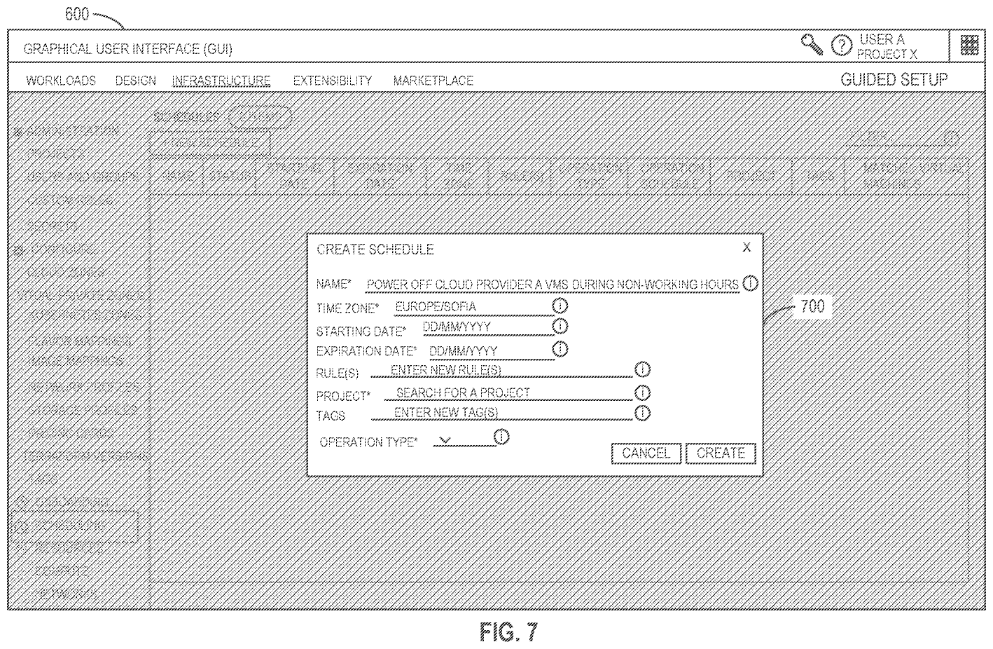

FIG. 7 is a second example GUI 700 to create an example schedule. For example, a user can select the new schedule GUI button 604 of FIG. 6 to launch the second GUI 700. In the illustrated example, a user can create a new schedule and store the new schedule in the datastore 270 of FIG. 2 as the schedule 272 by providing a name, a time zone, a starting date, an expiration date, one or more rules, a project (e.g., a project name, a project description or descriptor, etc.), one or more tags, and an operation type. For example, the name, time zone, starting date, expiration date, project, tags, and operation type in the second GUI 700 of FIG. 7 can correspond to one(s) of the schedule data fields 602 of FIG. 6. Additionally and/or alternatively, the second GUI 700 may include fewer or more schedule data fields than those depicted in the illustrated example of FIG. 7.

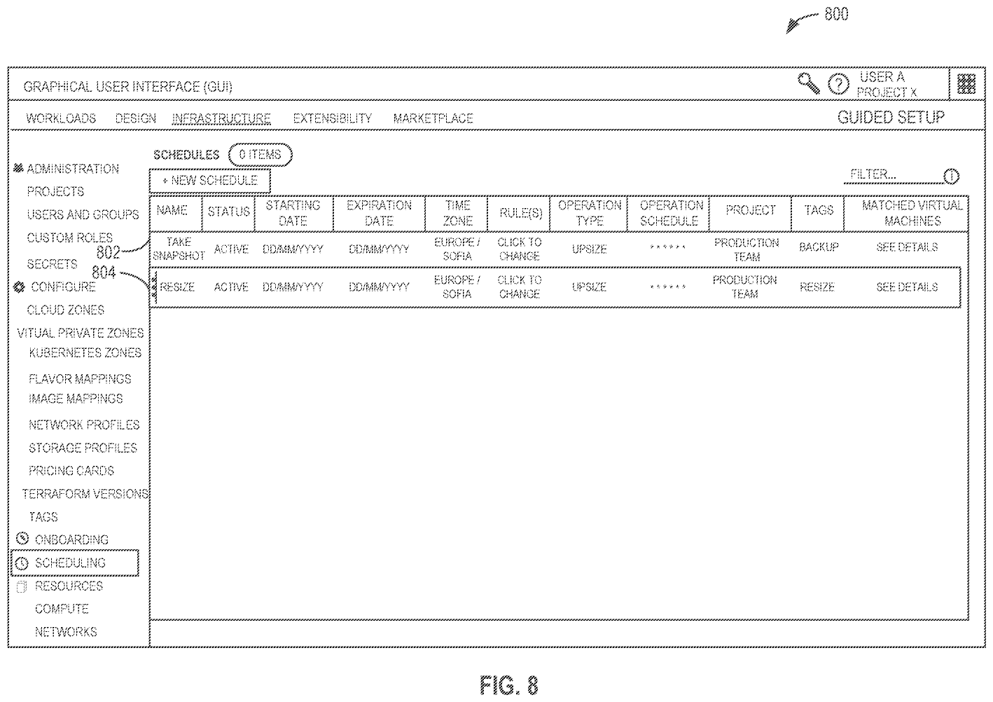

FIG. 8 is a third example GUI 800 to create an example schedule. For example, the third GUI 800 can be an instance of the first GUI 600 of FIG. 6 after a user generated a new schedule via the second GUI 700 of FIG. 6. For example, the third GUI 800 can include a first example schedule 802 and a second example schedule 804. In some examples, the schedule 272 of FIG. 2 can be implemented by the first schedule 802 and/or the second schedule 804 of FIG. 8.

The first schedule 802 of the illustrated example of FIG. 8 specifies, defines, etc., that the schedule name is “Take Snapshot,” the time zone is Europe/Sofia (e.g., Sofia, Bulgaria), the operation type is a snapshot operation (e.g., an operation to capture a snapshot of a virtual resource), the operation schedule is “0 30 19 * * *,” the project has a name of “Production Team,” and the tags include the text “backup.” The first schedule 802 of the illustrated example includes one or more first rules. For example, the one or more first rules can be added, removed, changed, and/or otherwise modified by selecting the “CLICK TO CHANGE” field of the first schedule 802. For example, by selecting the “CLICK TO CHANGE” field of the first schedule 802, a new or different GUI (e.g., a fourth GUI) can be launched to facilitate entering change(s) to the one or more first rules. In some examples, the one or more first rules of the first schedule 802 can correspond to one(s) of the rules 274 of FIG. 2. For example, the one or more first rules of the first schedule 802 can include threshold(s) (e.g., utilization threshold(s)) and/or any other condition, a circumstance, etc., that, when satisfied, triggered, and/or otherwise met, can cause the action/operation to be undertaken in connection with one(s) of the one or more virtual resources specified by the first schedule 802.

In the illustrated example, the operation schedule is implemented by a cron expression of “0 30 19 * * *,” where 0 can represent the hour (e.g., 0 in a 24-hour format, which can be midnight), 30 can represent the minute (e.g., 30 in a range of 0-59 minutes), and 19 can represent the day (e.g., day 19 in a month). The remaining fields of the cron expression are represented by “*” to indicate that other fields are not needed, such as the month or day of the week. For example, the cron expression of “0 30 19 * * *” in the illustrated example can represent that the snapshot operation is to be performed on the 19th day of the month at 00:30:00 (24-hour time format of hours:minutes:seconds (hh:mm:ss)).

The second schedule 804 of the illustrated example of FIG. 8 specifies, defines, etc., that the schedule name is “Resize,” the time zone is Europe/Sofia (e.g., Sofia, Bulgaria), the operation type is a downsize operation (e.g., an operation to reduce resources allocated to a VM or container), the operation schedule is “*,” the project has a name of “Production Team, and the tags include the text “resize.” The second schedule 804 of the illustrated example includes one or more second rules. For example, the one or more second rules can be added, removed, changed, and/or otherwise modified by selecting the “CLICK TO CHANGE” field of the second schedule 804. For example, by selecting the “CLICK TO CHANGE” field of the first schedule 802, a new or different GUI (e.g., the fourth GUI or a fifth GUI) can be launched to facilitate entering change(s) to the one or more second rules. In some examples, the one or more second rules of the second schedule 804 can correspond to one(s) of the rules 274 of FIG. 2. For example, the one or more second rules of the second schedule 804 can include threshold(s) (e.g., utilization threshold(s)) and/or any other condition, a circumstance, etc., that, when satisfied, triggered, and/or otherwise met, can cause the action/operation to be undertaken in connection with one(s) of the one or more virtual resources specified by the second schedule 804.

In the illustrated example, the operation schedule is implemented by a cron expression of “*,” where “*” indicates that the downsize operation is to be performed whenever one or more of the rules 274 are triggered. For example, the downsize operation can be performed when a utilization parameter of an applicable virtual resource falls below a utilization threshold.

Flowcharts representative of example machine readable instructions, which may be executed to configure processor circuitry to implement the LMC circuitry 200 of FIG. 2, are shown in FIGS. 9-13. The machine readable instructions may be one or more executable programs or portion(s) of an executable program for execution by processor circuitry, such as the processor circuitry 1412 shown in the example processor platform 1400 discussed below in connection with FIG. 14 and/or the example processor circuitry discussed below in connection with FIGS. 15 and/or 16. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 9-13, many other methods of implementing the example LMC circuitry 200 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 9-13 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 9 is a flowchart representative of example machine readable instructions and/or example operations 900 that may be executed and/or instantiated by processor circuitry to effectuate schedule-based lifecycle management of a virtual resource in a virtualized environment. The example machine readable instructions and/or the example operations 900 of FIG. 9 begin at block 902, at which the example LMC circuitry 200 generates a schedule including a rule to trigger an operation associated with a virtual resource of a virtualized environment when the rule is invoked. For example, the schedule generation circuitry 220 (FIG. 2) can generate the second schedule 804 of FIG. 8 to trigger the downsize operation when one of the rules 274 is invoked or triggered. In some examples, the one of the rules 274 can be to shut down a virtual resource hosted by the first cloud provider 108 of FIG. 1 when a utilization parameter of the virtual resource drops below a utilization threshold.

At block 904, the example LMC circuitry 200 identifies the virtual resource after determining that the rule corresponds to the virtual resource. For example, the resource identification circuitry 240 (FIG. 2) can determine that the one of the rules 274 is applicable to virtual resources hosted by the first cloud provider 108. In some examples, the resource identification circuitry 240 can query the first cloud provider 108 for virtual resources hosted on behalf of the private cloud 106. In some examples, the resource identification circuitry 240 can determine that the first virtual resource 122 is hosted by the first cloud provider 108 and thereby identify that the one of the rules 274 is applicable to the first virtual resource 122.

At block 906, the example LMC circuitry 200 executes the operation after determining that a value of a utilization parameter of the virtual resource satisfies a threshold. For example, the operation execution circuitry 260 (FIG. 2) can perform the downsize operation on the first virtual resource 122 after a determination that a compute utilization of 20% of the first virtual resource 122 is below a compute utilization threshold of 25%. In response to executing the operation after determining that a value of a utilization parameter of the virtual resource satisfies a threshold at block 906, the example machine readable instructions and/or the example operations 900 of FIG. 9 conclude.

FIG. 10 is a flowchart representative of example machine readable instructions and/or example operations 1000 that may be executed and/or instantiated by processor circuitry to effectuate schedule-based lifecycle management of a virtual resource in a virtualized environment. The example machine readable instructions and/or the example operations 1000 of FIG. 10 begin at block 1002, at which the example LMC circuitry 200 generates schedules to perform lifecycle management of virtual resources. For example, the schedule generation circuitry 220 (FIG. 2) can generate the schedules 802, 804 of FIG. 8 to perform lifecycle management of one(s) of the virtual resources 122, 124, 126 of FIG. 1.

At block 1004, the example LMC circuitry 200 determines whether a timer has elapsed to check the schedules. For example, the schedule evaluation circuitry 230 (FIG. 2) can determine whether a time period has passed since a previous evaluation of the schedules 802, 804. In some examples, the schedule evaluation circuitry 230 can determine to check the schedules 802, 804 for the first time.

If, at block 1004, the example LMC circuitry 200 determines that a timer has not elapsed to check the schedules, control proceeds to block 1020. Otherwise, control proceeds to block 1006.

At block 1006, the example LMC circuitry 200 selects a schedule of interest to process. For example, the schedule evaluation circuitry 230 can select the second schedule 804 of FIG. 8 to evaluate and/or otherwise process.

At block 1008, the example LMC circuitry 200 identifies one(s) of the virtual resources corresponding to the schedule. For example, the resource identification circuitry 240 (FIG. 2) can determine that the second schedule 804 is applicable to the first cloud provider 108 of FIG. 1. In some examples, the resource identification circuitry 240 can identify the first virtual resource 122 as corresponding to the second schedule 804 based on a determination that the first cloud provider 108 hosts the first virtual resource 122.

At block 1010, the example LMC circuitry 200 obtains utilization data associated with the one(s) of the virtual resources. For example, the interface circuitry 210 (FIG. 2) can request utilization data from the first virtual resource 122, and/or, more generally, the first cloud provider 108. In some examples, the utilization data can include a compute utilization parameter, a storage utilization parameter, a network utilization parameter, etc., associated with the first virtual resource 122.

At block 1012, the example LMC circuitry 200 identifies of the virtual resources whose utilization data satisfies utilization threshold(s). For example, the rule evaluation circuitry 250 (FIG. 2) can determine that the second schedule 804 includes a rule that specifies downsizing the first virtual resource 122 if a value of the compute utilization parameter of the first virtual resource 122 is below a compute utilization threshold. In some examples, the rule evaluation circuitry 250 can determine that the rule is triggered based on a determination that a compute utilization parameter value of 15% of the first virtual resource 122 is below a compute utilization threshold of 20%.

At block 1014, the example LMC circuitry 200 performs schedule action(s) on the identified one(s) of the one(s) of the virtual resources. For example, the operation execution circuitry 260 (FIG. 2) can execute the downsize operation on the first virtual resource 122 in response to invocation or triggering of the rule.

At block 1016, the example LMC circuitry 200 updates the schedule-based on last run time and status. For example, the schedule evaluation circuitry 230 can update the second schedule 804 with data, such as a timestamp corresponding to the instant schedule evaluation and/or a status, such as an execution of the downsize operation, a success status, etc.

At block 1018, the example LMC circuitry 200 determines whether to select another schedule of interest to process. For example, the schedule evaluation circuitry 230 can determine to select the first schedule 802 to process.

If, at block 1018, the example LMC circuitry 200 determines to select another schedule of interest to process, control returns to block 1006. Otherwise, control proceeds to block 1020.

At block 1020, the example LMC circuitry 200 determines whether to continue monitoring the virtual resources. For example, the schedule evaluation circuitry 230 can determine whether to evaluate (e.g., iteratively evaluate) one(s) of the schedules 802, 804 to perform lifecycle management associated with the virtual resources 122, 124, 126 of FIG. 1. If, at block 1020, the example LMC circuitry 200 determines to continue monitoring the virtual resources, control returns to block 1004. Otherwise, the example machine readable instructions and/or the example operations 1000 of FIG. 10 conclude.

FIG. 11 is a flowchart representative of example machine readable instructions and/or example operations 1100 that may be executed and/or instantiated by processor circuitry to generate an example schedule. The example machine readable instructions and/or the example operations 1100 of FIG. 11 begin at block 1102, at which the example LMC circuitry 200 obtains a request to create a schedule including schedule data fields for enforcement of a rule. For example, the interface circuitry 210 (FIG. 2) can obtain a request from the user interface 402 (FIG. 4) to generate the schedules 802, 804 of FIG. 8, which can include one(s) of the schedule data fields 602 of FIG. 6, for enforcement of one(s) of the rules 274 (FIG. 2).

At block 1104, the example LMC circuitry 200 configures one of the schedule data fields with a name of a cloud provider associated with a virtual resource. For example, the schedule generation circuitry 220 (FIG. 2) can set a value of one of the schedule data fields 602 with a name of the first cloud provider 108 of FIG. 1.

At block 1106, the example LMC circuitry 200 configures one of the schedule data fields with a time zone. For example, the schedule generation circuitry 220 can set a value of one of the schedule data fields 602 with a time zone associated with at least one of the first cloud provider 108 or the private cloud 106 of FIG. 1.

At block 1108, the example LMC circuitry 200 configures one of the schedule data fields with a first timestamp at which to start enforcement of the rule. For example, the schedule generation circuitry 220 can set a value of one of the schedule data fields 602 with a first timestamp at which to start enforcement of one or more of the rules 274 on the first virtual resource 122.

At block 1110, the example LMC circuitry 200 configures one of the schedule data fields with a second timestamp at which to end enforcement of the rule. For example, the schedule generation circuitry 220 can set a value of one of the schedule data fields 602 with a second timestamp at which to end enforcement of the one or more of the rules 274 on the first virtual resource 122.

At block 1112, the example LMC circuitry 200 configures one of the schedule data fields with a project name. For example, the schedule generation circuitry 220 can set a value of one of the schedule data fields 602 with a project name associated with deployment of the private cloud 106 and/or the first virtual resource 122.

At block 1114, the example LMC circuitry 200 configures one of the schedule data fields with tags. For example, the schedule generation circuitry 220 can set a value of one of the schedule data fields 602 with one or more tags.

At block 1116, the example LMC circuitry 200 configures one of the schedule data fields with a type of operation to be executed in response to enforcement of the rule. For example, the schedule generation circuitry 220 can set a value of one of the schedule data fields 602 with a type of operation, such as a snapshot operation or resize operation, to be executed in response to enforcement of the rule on the first virtual resource 122.

At block 1118, the example LMC circuitry 200 configures one of the schedule data fields with threshold(s) associated with triggering of the rule. For example, the schedule generation circuitry 220 can set a value of one of the schedule data fields 602 with a threshold, such as a compute utilization threshold, associated with triggering of the one or more of the rules 274.

At block 1120, the example LMC circuitry 200 configures other one(s) of the schedule data fields with other parameter(s). For example, the schedule generation circuitry 220 can set a value of one of the schedule data fields 602 with any other value, data, etc., to support evaluation of the schedules 802, 804. After configuring the other one(s) of the schedule data fields with other parameter(s) at block 1120, the example machine readable instructions and/or the example operations 1100 of FIG. 11 conclude.

FIG. 12 is a flowchart representative of example machine readable instructions and/or example operations 1200 that may be executed and/or instantiated by processor circuitry to execute an action after invoking a rule of a schedule. The example machine readable instructions and/or the example operations 1200 of FIG. 12 begin at block 1202, at which the example LMC circuitry 200 determines whether a timer has elapsed to check a schedule. For example, the schedule evaluation circuitry 230 (FIG. 2) can determine whether a time period has passed since a previous evaluation of the schedules 802, 804. In some examples, the schedule evaluation circuitry 230 can determine to check the schedules 802, 804 for the first time.

If, at block 1202, the example LMC circuitry 200 determines that a timer has not elapsed to check a schedule, control proceeds to block 1222. Otherwise, control proceeds to block 1204.

At block 1204, the example LMC circuitry 200 obtains a request for utilization data for virtual resources of a cloud provider associated with the schedule. For example, the interface circuitry 210 (FIG. 2) can obtain a request for utilization data for virtual resource(s) of the first cloud provider 108 associated with at least one of the first schedule 802 or the second schedule 804.

At block 1206, the example LMC circuitry 200 identifies the virtual resources corresponding to the cloud provider. For example, the resource identification circuitry 240 (FIG. 2) can identify the first virtual resource 122 as corresponding to the first cloud provider 108.

At block 1208, the example LMC circuitry 200 obtains utilization parameters for the virtual resources. For example, the interface circuitry 210 can obtain utilization parameters for the first virtual resource 122, which can include a value of a compute utilization parameter, a storage utilization parameter, a memory utilization parameter, etc.

At block 1210, the example LMC circuitry 200 selects a virtual resource. For example, the rule evaluation circuitry 250 (FIG. 2) can select the first virtual resource 122.

At block 1212, the example LMC circuitry 200 determines whether the virtual resource has a utilization parameter that satisfies a threshold specified by a schedule rule. For example, the rule evaluation circuitry 250 can determine whether the first virtual resource 122 has a value of a utilization parameter, such as a compute utilization parameter, that satisfies a threshold specified by a schedule rule of the at least one of the first schedule 802 or the second schedule 804.

If, at block 1212, the example LMC circuitry 200 determines that the virtual resource does not have a utilization parameter that satisfies a threshold specified by a schedule rule, control proceeds to block 1216. Otherwise, control proceeds to block 1214.

At block 1214, the example LMC circuitry 200 at least one of powers on, powers off, or resizes the virtual resource. For example, after a determination that a value of a storage utilization of the first virtual resource 122 exceeds a storage utilization threshold, the operation execution circuitry 260 (FIG. 2) can perform a resize operation specified by at least one of the first schedule 802 or the second schedule 804. In some examples, the resize operation can be an upsize operation, which can be implemented by the operation execution circuitry 260 adding storage resources to the first virtual resource 122. Additionally and/or alternatively, the operation execution circuitry 260 may carry out a different operation, such as a power on or power off operation in connection with the first virtual resource 122.

At block 1216, the example LMC circuitry 200 determines whether to create a snapshot of the virtual resource based on a schedule rule. For example, the rule evaluation circuitry 250 can determine whether at least one of the first schedule 802 or the second schedule 804 includes a rule that, when triggered, causes a snapshot of the first virtual resource 122 to be captured. If, at block 1216, the example LMC circuitry 200 determines not to create a snapshot of the virtual resource based on a schedule rule, control proceeds to block 1220. Otherwise, control proceeds to block 1218.

At block 1218, the example LMC circuitry 200 stores at least one of configuration data or workload data associated with the virtual resource to capture a snapshot of the virtual resource. For example, after a determination to capture a snapshot of the first virtual resource 122, the operation execution circuitry 260 can store at least one of configuration data or workload data associated with the first virtual resource 122 in the datastore 270 (FIG. 2) as one(s) of the snapshots 278 (FIG. 2).

At block 1220, the example LMC circuitry 200 determines whether to select another virtual resource. For example, the rule evaluation circuitry 250 can determine whether there is another virtual resource hosted by the first cloud provider 108 that is associated with at least one of the first schedule 802 or the second schedule 804.

If, at block 1220, the example LMC circuitry 200 determines to select another virtual resource, control returns to block 1210. Otherwise, control proceeds to block 1222.

At block 1222, the example LMC circuitry 200 determines whether to continue monitoring the virtual resources based on the schedule. For example, the schedule evaluation circuitry 230 can determine whether to continue evaluating at least one of the first schedule 802 or the second schedule 804.

If, at block 1222, the example LMC circuitry 200 determines to continue monitoring the virtual resources based on the schedule, control returns to block 1202. Otherwise, the example machine readable instructions and/or the example operations 1200 of FIG. 12 conclude.

FIG. 13 is a flowchart representative of example machine readable instructions and/or example operations 1300 that may be executed and/or instantiated by processor circuitry to execute an action based on a utilization parameter of a virtual resource. The example machine readable instructions and/or the example operations 1300 of FIG. 13 begin at block 1302, at which the example LMC circuitry 200 determines whether a value of a utilization parameter of a virtual resource is below a threshold. For example, the rule evaluation circuitry 250 (FIG. 2) can determine whether a value of a network utilization parameter (e.g., a value of 20% utilized, 50% utilized, etc.) for the first virtual resource 122 of FIG. 1 is below a network utilization threshold (e.g., a network utilization threshold of 25%, 60%, etc.). In some examples, the value of a network utilization parameter can be an indication of whether a network resource (e.g., a virtualized gateway, switch, router, interface, etc.) of the first virtual resource 122 is overutilized or underutilized.

If, at block 1302, the example LMC circuitry 200 determines that a value of a utilization parameter of a virtual resource is not below a threshold, control proceeds to block 1308. Otherwise, control proceeds to block 1304.

At block 1304, the example LMC circuitry 200 determines that the virtual resource is underutilized. For example, the rule evaluation circuitry 250 can determine that a network resource of the first virtual resource 122 is underutilized based on a determination that a value of the network utilization parameter is below and/or meets a network utilization threshold.

At block 1306, the example LMC circuitry 200 at least one of turns off the virtual resource or assigns the virtual resource to a different workload domain. For example, after a determination that the first virtual resource 122 is underutilized, the operation execution circuitry 260 (FIG. 2) can determine that the first virtual resource 122 can be turned off to conserve power, reduce virtual resources in use, etc. In some examples, after a determination that the first virtual resource 122 is underutilized, the operation execution circuitry 260 can determine that the first virtual resource 122 can be assigned to a different workload domain to achieve increased utilization of the first virtual resource 122. For example, the different workload domain can have network resource(s) that is/are overutilized and can use the first virtual resource 122 to reduce the demand placed on the network resource(s).

At block 1308, the example LMC circuitry 200 determines whether a value of a utilization parameter of a virtual resource is above a threshold. For example, the rule evaluation circuitry 250 can determine whether a value of a network utilization parameter (e.g., a value of 20% utilized, 50% utilized, etc.) for the first virtual resource 122 of FIG. 1 is above a network utilization threshold (e.g., a network utilization threshold of 25%, 60%, etc.).

If, at block 1308, the example LMC circuitry 200 determines that a value of a utilization parameter of a virtual resource is not above a threshold, the example machine readable instructions and/or the example operations 1300 of FIG. 13 conclude.

If, at block 1308, the example LMC circuitry 200 determines that a value of a utilization parameter of a virtual resource is above a threshold, then, at block 1310, the LMC circuitry 200 determines that the virtual resource is overutilized. For example, the rule evaluation circuitry 250 can determine that a network resource of the first virtual resource 122 is overutilized based on a determination that a value of the network utilization parameter is above and/or meets a network utilization threshold.

At block 1312, the example LMC circuitry 200 at least one of transfers a portion of a workload of the virtual resource to a different virtual resource or adds a quantity of resources to the virtual resource. For example, after a determination that the first virtual resource 122 is overutilized, the operation execution circuitry 260 can determine that a workload, or portion(s) thereof, can be transferred from the first virtual resource 122 to a different virtual resource to reduce the utilization of the first virtual resource 122. In some examples, after a determination that the first virtual resource 122 is overutilized, the operation execution circuitry 260 can determine to add resources (e.g., virtualizations of hardware resources, virtual resources, etc.) to the first virtual resource 122 to reduce the utilization of the first virtual resource 122. For example, the operation execution circuitry 260 can add a virtualized gateway, switch, router, etc., to the first virtual resource 122 to distribute a workload executed by the first virtual resource 122 to reduce the utilization of the first virtual resource 122. After at least one of a transfer of a portion of a workload of the virtual resource to a different virtual resource or an addition of a quantity of resources to the virtual resource at block 1312, the example machine readable instructions and/or the example operations 1300 of FIG. 13 conclude.

FIG. 14 is a block diagram of an example processor platform 1400 structured to execute and/or instantiate the example machine readable instructions and/or the example operations of FIGS. 9-13 to implement the example LMC circuitry 200 of FIG. 2. The processor platform 1400 can be, for example, a server, a personal computer, a workstation, a self-learning machine (e.g., a neural network), or any other type of computing device.

The processor platform 1400 of the illustrated example includes processor circuitry 1412. The processor circuitry 1412 of the illustrated example is hardware. For example, the processor circuitry 1412 can be implemented by one or more integrated circuits, logic circuits, FPGAs microprocessors, CPUs, GPUs, DSPs, and/or microcontrollers from any desired family or manufacturer. The processor circuitry 1412 may be implemented by one or more semiconductor based (e.g., silicon based) devices. In this example, the processor circuitry 1412 implements the schedule generation circuitry 220 (identified by SCHEDULE GEN CIRCUITRY), the schedule evaluation circuitry 230 (identified by SCHEDULE EVAL CIRCUITRY), the resource identification circuitry 240 (identified by RESOURCE ID CIRCUITRY), the rule evaluation circuitry 250 (identified by RULE EVAL CIRCUITRY), and the operation execution circuitry 260 (identified by OPERATION EXE CIRCUITRY) of FIG. 2.

The processor circuitry 1412 of the illustrated example includes a local memory 1413 (e.g., a cache, registers, etc.). The processor circuitry 1412 of the illustrated example is in communication with a main memory including a volatile memory 1414 and a non-volatile memory 1416 by a bus 1418. In this example, the bus 1418 implements the bus 280 of FIG. 2. The volatile memory 1414 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1416 may be implemented by flash memory and/or any other desired type of memory device. Access to the main memory 1414, 1416 of the illustrated example is controlled by a memory controller 1417.

The processor platform 1400 of the illustrated example also includes interface circuitry 1420. In this example, the interface circuitry 1420 implements the interface circuitry 210 of FIG. 2. The interface circuitry 1420 may be implemented by hardware in accordance with any type of interface standard, such as an Ethernet interface, a universal serial bus (USB) interface, a Bluetooth® interface, a near field communication (NFC) interface, a PCI interface, and/or a PCIe interface.

In the illustrated example, one or more input devices 1422 are connected to the interface circuitry 1420. The input device(s) 1422 permit(s) a user to enter data and/or commands into the processor circuitry 1412. The input device(s) 1422 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1424 are also connected to the interface circuitry 1420 of the illustrated example. The output devices 1424 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1420 of the illustrated example, thus, typically includes a graphics driver card, a graphics driver chip, and/or graphics processor circuitry such as a GPU.

The interface circuitry 1420 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1426. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1400 of the illustrated example also includes one or more mass storage devices 1428 to store software and/or data. Examples of such mass storage devices 1428 include magnetic storage devices, optical storage devices, floppy disk drives, HDDs, CDs, Blu-ray disk drives, redundant array of independent disks (RAID) systems, solid state storage devices such as flash memory devices, and DVD drives. In this example, the one or more mass storage devices 1428 implement the datastore 270 of FIG. 2, which includes the schedule 272, the rules 274, the parameters 276, and the snapshots 278 of FIG. 2.

The machine executable instructions 1432, which may be implemented by the machine readable instructions of FIGS. 9-13, may be stored in the mass storage device 1428, in the volatile memory 1414, in the non-volatile memory 1416, and/or on a removable non-transitory computer readable storage medium such as a CD or DVD.

FIG. 15 is a block diagram of an example implementation of the processor circuitry 1412 of FIG. 14. In this example, the processor circuitry 1412 of FIG. 14 is implemented by a microprocessor 1500. For example, the microprocessor 1500 may implement multi-core hardware circuitry such as a CPU, a DSP, a GPU, an XPU, etc. Although it may include any number of example cores 1502 (e.g., 1 core), the microprocessor 1500 of this example is a multi-core semiconductor device including N cores. The cores 1502 of the microprocessor 1500 may operate independently or may cooperate to execute machine readable instructions. For example, machine code corresponding to a firmware program, an embedded software program, or a software program may be executed by one of the cores 1502 or may be executed by multiple ones of the cores 1502 at the same or different times. In some examples, the machine code corresponding to the firmware program, the embedded software program, or the software program is split into threads and executed in parallel by two or more of the cores 1502. The software program may correspond to a portion or all of the machine readable instructions and/or the operations represented by the flowcharts of FIGS. 9-13.

The cores 1502 may communicate by a first example bus 1504. In some examples, the first bus 1504 may implement a communication bus to effectuate communication associated with one(s) of the cores 1502. For example, the first bus 1504 may implement at least one of an Inter-Integrated Circuit (I2C) bus, a Serial Peripheral Interface (SPI) bus, a PCI bus, or a PCIe bus. Additionally or alternatively, the first bus 1504 may implement any other type of computing or electrical bus. The cores 1502 may obtain data, instructions, and/or signals from one or more external devices by example interface circuitry 1506. The cores 1502 may output data, instructions, and/or signals to the one or more external devices by the interface circuitry 1506. Although the cores 1502 of this example include example local memory 1520 (e.g., Level 1 (L1) cache that may be split into an L1 data cache and an L1 instruction cache), the microprocessor 1500 also includes example shared memory 1510 that may be shared by the cores (e.g., Level 2 (L2 cache)) for high-speed access to data and/or instructions. Data and/or instructions may be transferred (e.g., shared) by writing to and/or reading from the shared memory 1510. The local memory 1520 of each of the cores 1502 and the shared memory 1510 may be part of a hierarchy of storage devices including multiple levels of cache memory and the main memory (e.g., the main memory 1414, 1416 of FIG. 14). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1502 may be referred to as a CPU, DSP, GPU, etc., or any other type of hardware circuitry. Each core 1502 includes control unit circuitry 1514, arithmetic and logic (AL) circuitry (sometimes referred to as an ALU) 1516, a plurality of registers 1518, the L1 cache 1520, and a second example bus 1522. Other structures may be present. For example, each core 1502 may include vector unit circuitry, single instruction multiple data (SIMD) unit circuitry, load/store unit (LSU) circuitry, branch/jump unit circuitry, floating-point unit (FPU) circuitry, etc. The control unit circuitry 1514 includes semiconductor-based circuits structured to control (e.g., coordinate) data movement within the corresponding core 1502. The AL circuitry 1516 includes semiconductor-based circuits structured to perform one or more mathematic and/or logic operations on the data within the corresponding core 1502. The AL circuitry 1516 of some examples performs integer based operations. In other examples, the AL circuitry 1516 also performs floating point operations. In yet other examples, the AL circuitry 1516 may include first AL circuitry that performs integer based operations and second AL circuitry that performs floating point operations. In some examples, the AL circuitry 1516 may be referred to as an Arithmetic Logic Unit (ALU). The registers 1518 are semiconductor-based structures to store data and/or instructions such as results of one or more of the operations performed by the AL circuitry 1516 of the corresponding core 1502. For example, the registers 1518 may include vector register(s), SIMD register(s), general purpose register(s), flag register(s), segment register(s), machine specific register(s), instruction pointer register(s), control register(s), debug register(s), memory management register(s), machine check register(s), etc. The registers 1518 may be arranged in a bank as shown in FIG. 15. Alternatively, the registers 1518 may be organized in any other arrangement, format, or structure including distributed throughout the core 1502 to shorten access time. The second bus 1522 may implement at least one of an I2C bus, a SPI bus, a PCI bus, or a PCIe bus

Each core 1502 and/or, more generally, the microprocessor 1500 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1500 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 16 is a block diagram of another example implementation of the processor circuitry 1412 of FIG. 14. In this example, the processor circuitry 1412 is implemented by FPGA circuitry 1600. The FPGA circuitry 1600 can be used, for example, to perform operations that could otherwise be performed by the example microprocessor 1500 of FIG. 15 executing corresponding machine readable instructions. However, once configured, the FPGA circuitry 1600 instantiates the machine readable instructions in hardware and, thus, can often execute the operations faster than they could be performed by a general purpose microprocessor executing the corresponding software.

More specifically, in contrast to the microprocessor 1500 of FIG. 15 described above (which is a general purpose device that may be programmed to execute some or all of the machine readable instructions represented by the flowcharts of FIGS. 9-13 but whose interconnections and logic circuitry are fixed once fabricated), the FPGA circuitry 1600 of the example of FIG. 16 includes interconnections and logic circuitry that may be configured and/or interconnected in different ways after fabrication to instantiate, for example, some or all of the machine readable instructions represented by the flowcharts of FIGS. 9-13. In particular, the FPGA circuitry 1600 may be thought of as an array of logic gates, interconnections, and switches. The switches can be programmed to change how the logic gates are interconnected by the interconnections, effectively forming one or more dedicated logic circuits (unless and until the FPGA circuitry 1600 is reprogrammed). The configured logic circuits enable the logic gates to cooperate in different ways to perform different operations on data received by input circuitry. Those operations may correspond to some or all of the software represented by the flowcharts of FIGS. 9-13. As such, the FPGA circuitry 1600 may be structured to effectively instantiate some or all of the machine readable instructions of the flowcharts of FIGS. 9-13 as dedicated logic circuits to perform the operations corresponding to those software instructions in a dedicated manner analogous to an ASIC. Therefore, the FPGA circuitry 1600 may perform the operations corresponding to the some or all of the machine readable instructions of FIGS. 9-13 faster than the general purpose microprocessor can execute the same.

In the example of FIG. 16, the FPGA circuitry 1600 is structured to be programmed (and/or reprogrammed one or more times) by an end user by a hardware description language (HDL) such as Verilog. The FPGA circuitry 1600 of FIG. 16, includes example input/output (I/O) circuitry 1602 to obtain and/or output data to/from example configuration circuitry 1604 and/or external hardware (e.g., external hardware circuitry) 1606. For example, the configuration circuitry 1604 may implement interface circuitry that may obtain machine readable instructions to configure the FPGA circuitry 1600, or portion(s) thereof. In some such examples, the configuration circuitry 1604 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1606 may implement the microprocessor 1500 of FIG. 15. The FPGA circuitry 1600 also includes an array of example logic gate circuitry 1608, a plurality of example configurable interconnections 1610, and example storage circuitry 1612. The logic gate circuitry 1608 and interconnections 1610 are configurable to instantiate one or more operations that may correspond to at least some of the machine readable instructions of FIGS. 9-13 and/or other desired operations. The logic gate circuitry 1608 shown in FIG. 16 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1608 to enable configuration of the electrical structures and/or the logic gates to form circuits to perform desired operations. The logic gate circuitry 1608 may include other electrical structures such as look-up tables (LUTs), registers (e.g., flip-flops or latches), multiplexers, etc.

The interconnections 1610 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1608 to program desired logic circuits.

The storage circuitry 1612 of the illustrated example is structured to store result(s) of the one or more of the operations performed by corresponding logic gates. The storage circuitry 1612 may be implemented by registers or the like. In the illustrated example, the storage circuitry 1612 is distributed amongst the logic gate circuitry 1608 to facilitate access and increase execution speed.

The example FPGA circuitry 1600 of FIG. 16 also includes example Dedicated Operations Circuitry 1614. In this example, the Dedicated Operations Circuitry 1614 includes special purpose circuitry 1616 that may be invoked to implement commonly used functions to avoid the need to program those functions in the field. Examples of such special purpose circuitry 1616 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1600 may also include example general purpose programmable circuitry 1618 such as an example CPU 1620 and/or an example DSP 1622. Other general purpose programmable circuitry 1618 may additionally or alternatively be present such as a GPU, an XPU, etc., that can be programmed to perform other operations.

Although FIGS. 15 and 16 illustrate two example implementations of the processor circuitry 1412 of FIG. 14, many other approaches are contemplated. For example, as mentioned above, modern FPGA circuitry may include an on-board CPU, such as one or more of the example CPU 1620 of FIG. 16. Therefore, the processor circuitry 1412 of FIG. 14 may additionally be implemented by combining the example microprocessor 1500 of FIG. 15 and the example FPGA circuitry 1600 of FIG. 16. In some such hybrid examples, a first portion of the machine readable instructions represented by the flowcharts of FIGS. 9-13 may be executed by one or more of the cores 1502 of FIG. 15 and a second portion of the machine readable instructions represented by the flowcharts of FIGS. 9-13 may be executed by the FPGA circuitry 1600 of FIG. 16.

In some examples, the processor circuitry 1412 of FIG. 14 may be in one or more packages. For example, the microprocessor 1500 of FIG. 15 and/or the FPGA circuitry 1600 of FIG. 16 may be in one or more packages. In some examples, an XPU may be implemented by the processor circuitry 1412 of FIG. 14, which may be in one or more packages. For example, the XPU may include a CPU in one package, a DSP in another package, a GPU in yet another package, and an FPGA in still yet another package.

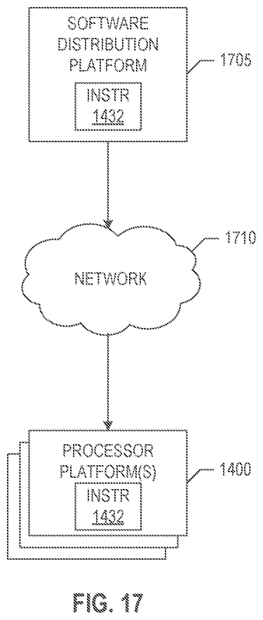

FIG. 17 is a block diagram of an example software distribution platform 1705, which may be implemented by one or more servers, to distribute software (e.g., software corresponding to the example machine readable instructions and/or the example operations of FIGS. 9-13) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers). For example, the software distribution platform 1705 may distribute software such as the example machine readable instructions 1432 of FIG. 14 to hardware devices owned and/or operated by third parties. The example software distribution platform 1705 may be implemented by any computer server, data facility, cloud service, etc., capable of storing and transmitting software to other computing devices. The third parties may be customers of the entity owning and/or operating the software distribution platform 1705. For example, the entity that owns and/or operates the software distribution platform 1705 may be a developer, a seller, and/or a licensor of software such as the example machine readable instructions 1432 of FIG. 14. The third parties may be consumers, users, retailers, OEMs, etc., who purchase and/or license the software for use and/or re-sale and/or sub-licensing. In the illustrated example, the software distribution platform 1705 includes one or more servers and one or more storage devices. The storage devices store the machine readable instructions 1432, which may correspond to the example machine readable instructions and/or the example operations 900, 1000, 1100, 1200, 1300 of FIGS. 9-13, as described above. The one or more servers of the example software distribution platform 1705 are in communication with a network 1710, which may correspond to any one or more of the Internet and/or any of the example networks 1426 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1432 from the software distribution platform 1705. For example, the software, which may correspond to the example machine readable instructions and/or the example operations 900, 1000, 1100, 1200, 1300 of FIGS. 9-13, may be downloaded to the example processor platform 1400, which is to execute the machine readable instructions 1432 to implement the example LMC circuitry 200 of FIG. 2. In some example, one or more servers of the software distribution platform 1705 periodically offer, transmit, and/or force updates to the software (e.g., the example machine readable instructions 1432 of FIG. 14) to ensure improvements, patches, updates, etc., are distributed and applied to the software at the end user devices.

From the foregoing, it will be appreciated that example systems, methods, apparatus, and articles of manufacture have been disclosed for schedule-based lifecycle management. Disclosed systems, methods, apparatus, and articles of manufacture improve the efficiency of using a computing device by periodically evaluating schedules to effectuate Day 0, Day 1, and/or Day 2 operations to reduce the time needed to design, deploy, and/or maintain a virtualized environment. Disclosed systems, methods, apparatus, and articles of manufacture utilize schedule-based lifecycle management to reduce and/or eliminate downtime of a virtualized environment, which can result in additional workloads being completed. Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture for schedule-based lifecycle management are disclosed herein. Further examples and combinations thereof include the following:

Example 1 includes an apparatus for lifecycle management in a virtualized environment, the apparatus comprising at least one memory, machine readable instructions, and processor circuitry to at least one of execute or instantiate the machine readable instructions to at least generate a schedule including a rule, the rule to trigger an operation associated with a virtual resource of the virtualized environment, identify the virtual resource after a first determination that the rule corresponds to the virtual resource, and execute the operation after a second determination that a value of a utilization parameter of the virtual resource satisfies a threshold.

Example 2 includes the apparatus of example 1, wherein the processor circuitry is to configure a first data field of the schedule with a name of a cloud provider associated with the virtual resource, configure a second data field of the schedule with a first timestamp at which to start enforcement of the rule, configure a third data field of the schedule with a second timestamp at which to end enforcement of the rule, configure a fourth data field with the operation to be executed after the triggering of the rule, and generate the schedule based on at least one of the first data field, the second data field, the third data field, or the fourth data field.

Example 3 includes the apparatus of example 1, wherein the operation is a snapshot operation, and the processor circuitry is to obtain configuration data associated with a configuration of the virtual resource, obtain workload data associated with a progress of execution of a workload by the virtual resource, and store the configuration data and the workload data in a datastore to capture a snapshot of the virtual resource.

Example 4 includes the apparatus of example 1, wherein the virtual resource is in a first workload domain, the operation is a downsize operation, the value of the utilization parameter satisfies the threshold based on the value being less than the threshold, and the processor circuitry is to determine that the virtual resource is underutilized based on the value being less than the threshold, and at least one of turn off the virtual resource or assign the virtual resource to a second workload domain to execute a workload.

Example 5 includes the apparatus of example 1, wherein the virtual resource is a first virtual resource, the first virtual resource represents a first quantity of hardware resources, the operation is an upsize operation, the value of the utilization parameter satisfies the threshold based on the value being greater than the threshold, and the processor circuitry is to determine that the first virtual resource is overutilized based on the value being greater than the threshold, and at least one of transfer a portion of a workload of the first virtual resource to a second virtual resource or add a second quantity of hardware resources to the first virtual resource.

Example 6 includes the apparatus of example 1, wherein the virtual resource is powered off at a first time, and the processor circuitry is to turn on the virtual resource to execute the operation at a second time after the first time.

Example 7 includes the apparatus of example 1, wherein the utilization parameter is a compute utilization, a memory utilization, or a storage utilization.

Example 8 includes at least one non-transitory machine readable storage medium comprising instructions that, when executed, cause processor circuitry to at least generate a schedule including a rule, the rule to trigger an operation associated with a virtual resource of the virtualized environment, identify the virtual resource after a first determination that the rule corresponds to the virtual resource, and execute the operation after a second determination that a value of a utilization parameter of the virtual resource satisfies a threshold.

Example 9 includes the at least one non-transitory machine readable storage medium of example 8, wherein the instructions, when executed, cause the processor circuitry to configure a first data field of the schedule with a name of a cloud provider associated with the virtual resource, configure a second data field of the schedule with a first timestamp at which to start enforcement of the rule, configure a third data field of the schedule with a second timestamp at which to end enforcement of the rule, configure a fourth data field with the operation to be executed after the triggering of the rule, and generate the schedule based on at least one of the first data field, the second data field, the third data field, or the fourth data field.

Example 10 includes the at least one non-transitory machine readable storage medium of example 8, wherein the operation is a snapshot operation, and the instructions, when executed, cause the processor circuitry to obtain configuration data associated with a configuration of the virtual resource, obtain workload data associated with a progress of execution of a workload by the virtual resource, and store the configuration data and the workload data in a datastore to capture a snapshot of the virtual resource.

Example 11 includes the at least one non-transitory machine readable storage medium of example 8, wherein the virtual resource is in a first workload domain, the operation is a downsize operation, the value of the utilization parameter satisfies the threshold based on the value being less than the threshold, and the instructions, when executed, cause the processor circuitry to determine that the virtual resource is underutilized based on the value being less than the threshold, and at least one of turn off the virtual resource or assign the virtual resource to a second workload domain to execute a workload.

Example 12 includes the at least one non-transitory machine readable storage medium of example 8, wherein the virtual resource is a first virtual resource, the first virtual resource represents a first quantity of hardware resources, the operation is an upsize operation, the value of the utilization parameter satisfies the threshold based on the value being greater than the threshold, and the instructions, when executed, cause the processor circuitry to determine that the first virtual resource is overutilized based on the value being greater than the threshold, and at least one of transfer a portion of a workload of the first virtual resource to a second virtual resource or add a second quantity of hardware resources to the first virtual resource.

Example 13 includes the at least one non-transitory machine readable storage medium of example 8, wherein the virtual resource is powered off at a first time, and the instructions, when executed, cause the processor circuitry to turn on the virtual resource to execute the operation at a second time after the first time.

Example 14 includes the at least one non-transitory machine readable storage medium of example 8, wherein the utilization parameter is a compute utilization, a memory utilization, or a storage utilization.

Example 15 includes a method for lifecycle management in a virtualized environment, the method comprising generating a schedule including a rule, the rule to trigger an operation associated with a virtual resource of the virtualized environment, identifying the virtual resource after a first determination that the rule corresponds to the virtual resource, and executing the operation after a second determination that a value of a utilization parameter of the virtual resource satisfies a threshold.

Example 16 includes the method of example 15, further including configuring a first data field of the schedule with a name of a cloud provider associated with the virtual resource, configuring a second data field of the schedule with a first timestamp at which to start enforcement of the rule, configuring a third data field of the schedule with a second timestamp at which to end enforcement of the rule, configuring a fourth data field with the operation to be executed after the triggering of the rule, and generating the schedule based on at least one of the first data field, the second data field, the third data field, or the fourth data field.

Example 17 includes the method of example 15, wherein the operation is a snapshot operation, and the method further including obtaining configuration data associated with a configuration of the virtual resource, obtaining workload data associated with a progress of execution of a workload by the virtual resource, and storing the configuration data and the workload data in a datastore to capture a snapshot of the virtual resource.

Example 18 includes the method of example 15, wherein the virtual resource is in a first workload domain, the operation is a downsize operation, the value of the utilization parameter satisfies the threshold based on the value being less than the threshold, and the method further including determining that the virtual resource is underutilized based on the value being less than the threshold, and at least one of turning off the virtual resource or assigning the virtual resource to a second workload domain to execute a workload.

Example 19 includes the method of example 15, wherein the virtual resource is a first virtual resource, the first virtual resource represents a first quantity of hardware resources, the operation is an upsize operation, the value of the utilization parameter satisfies the threshold based on the value being greater than the threshold, and the method further including determining that the first virtual resource is overutilized based on the value being greater than the threshold, and at least one of transferring a portion of a workload of the first virtual resource to a second virtual resource or adding a second quantity of hardware resources to the first virtual resource.

Example 20 includes the method of example 15, wherein the virtual resource is powered off at a first time, and the method further including turning on the virtual resource to execute the operation at a second time after the first time.

Example 21 includes the method of example 15, wherein the utilization parameter is a compute utilization, a memory utilization, or a storage utilization.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. An apparatus for lifecycle management in a virtualized environment, the apparatus comprising:
at least one memory;
machine readable instructions; and
processor circuitry to at least one of execute or instantiate the machine readable instructions to at least:
generate a schedule including a rule, the rule to trigger an operation associated with a virtual resource of the virtualized environment;
identify the virtual resource after a first determination that the rule corresponds to the virtual resource; and
execute the operation after a second determination that a value of a utilization parameter of the virtual resource satisfies a threshold.

2. The apparatus of claim 1, wherein the processor circuitry is to:
configure a first data field of the schedule with a name of a cloud provider associated with the virtual resource;
configure a second data field of the schedule with a first timestamp at which to start enforcement of the rule;
configure a third data field of the schedule with a second timestamp at which to end enforcement of the rule;
configure a fourth data field with the operation to be executed after the triggering of the rule; and
generate the schedule based on at least one of the first data field, the second data field, the third data field, or the fourth data field.

3. The apparatus of claim 1, wherein the operation is a snapshot operation, and the processor circuitry is to:
obtain configuration data associated with a configuration of the virtual resource;
obtain workload data associated with a progress of execution of a workload by the virtual resource; and
store the configuration data and the workload data in a datastore to capture a snapshot of the virtual resource.

4. The apparatus of claim 1, wherein the virtual resource is in a first workload domain, the operation is a downsize operation, the value of the utilization parameter satisfies the threshold based on the value being less than the threshold, and the processor circuitry is to:
determine that the virtual resource is underutilized based on the value being less than the threshold; and
at least one of turn off the virtual resource or assign the virtual resource to a second workload domain to execute a workload.

5. The apparatus of claim 1, wherein the virtual resource is a first virtual resource, the first virtual resource represents a first quantity of hardware resources, the operation is an upsize operation, the value of the utilization parameter satisfies the threshold based on the value being greater than the threshold, and the processor circuitry is to:
determine that the first virtual resource is overutilized based on the value being greater than the threshold; and
at least one of transfer a portion of a workload of the first virtual resource to a second virtual resource or add a second quantity of hardware resources to the first virtual resource.

6. The apparatus of claim 1, wherein the virtual resource is powered off at a first time, and the processor circuitry is to turn on the virtual resource to execute the operation at a second time after the first time.

7. The apparatus of claim 1, wherein the utilization parameter is a compute utilization, a memory utilization, or a storage utilization.

8. At least one non-transitory machine readable storage medium comprising instructions that, when executed, cause processor circuitry to at least:
generate a schedule including a rule, the rule to trigger an operation associated with a virtual resource of the virtualized environment;
identify the virtual resource after a first determination that the rule corresponds to the virtual resource; and
execute the operation after a second determination that a value of a utilization parameter of the virtual resource satisfies a threshold.

9. The at least one non-transitory machine readable storage medium of claim 8, wherein the instructions, when executed, cause the processor circuitry to:
configure a first data field of the schedule with a name of a cloud provider associated with the virtual resource;
configure a second data field of the schedule with a first timestamp at which to start enforcement of the rule;
configure a third data field of the schedule with a second timestamp at which to end enforcement of the rule;
configure a fourth data field with the operation to be executed after the triggering of the rule; and
generate the schedule based on at least one of the first data field, the second data field, the third data field, or the fourth data field.

10. The at least one non-transitory machine readable storage medium of claim 8, wherein the operation is a snapshot operation, and the instructions, when executed, cause the processor circuitry to:
obtain configuration data associated with a configuration of the virtual resource;
obtain workload data associated with a progress of execution of a workload by the virtual resource; and
store the configuration data and the workload data in a datastore to capture a snapshot of the virtual resource.

11. The at least one non-transitory machine readable storage medium of claim 8, wherein the virtual resource is in a first workload domain, the operation is a downsize operation, the value of the utilization parameter satisfies the threshold based on the value being less than the threshold, and the instructions, when executed, cause the processor circuitry to:
determine that the virtual resource is underutilized based on the value being less than the threshold; and
at least one of turn off the virtual resource or assign the virtual resource to a second workload domain to execute a workload.

12. The at least one non-transitory machine readable storage medium of claim 8, wherein the virtual resource is a first virtual resource, the first virtual resource represents a first quantity of hardware resources, the operation is an upsize operation, the value of the utilization parameter satisfies the threshold based on the value being greater than the threshold, and the instructions, when executed, cause the processor circuitry to:
determine that the first virtual resource is overutilized based on the value being greater than the threshold; and
at least one of transfer a portion of a workload of the first virtual resource to a second virtual resource or add a second quantity of hardware resources to the first virtual resource.

13. The at least one non-transitory machine readable storage medium of claim 8, wherein the virtual resource is powered off at a first time, and the instructions, when executed, cause the processor circuitry to turn on the virtual resource to execute the operation at a second time after the first time.

14. The at least one non-transitory machine readable storage medium of claim 8, wherein the utilization parameter is a compute utilization, a memory utilization, or a storage utilization.

15. A method for lifecycle management in a virtualized environment, the method comprising
generating a schedule including a rule, the rule to trigger an operation associated with a virtual resource of the virtualized environment;
identifying the virtual resource after a first determination that the rule corresponds to the virtual resource; and
executing the operation after a second determination that a value of a utilization parameter of the virtual resource satisfies a threshold.

16. The method of claim 15, further including:
configuring a first data field of the schedule with a name of a cloud provider associated with the virtual resource;
configuring a second data field of the schedule with a first timestamp at which to start enforcement of the rule;
configuring a third data field of the schedule with a second timestamp at which to end enforcement of the rule;
configuring a fourth data field with the operation to be executed after the triggering of the rule; and
generating the schedule based on at least one of the first data field, the second data field, the third data field, or the fourth data field.

17. The method of claim 15, wherein the operation is a snapshot operation, and the method further including:
obtaining configuration data associated with a configuration of the virtual resource;
obtaining workload data associated with a progress of execution of a workload by the virtual resource; and
storing the configuration data and the workload data in a datastore to capture a snapshot of the virtual resource.

18. The method of claim 15, wherein the virtual resource is in a first workload domain, the operation is a downsize operation, the value of the utilization parameter satisfies the threshold based on the value being less than the threshold, and the method further including:
determining that the virtual resource is underutilized based on the value being less than the threshold; and
at least one of turning off the virtual resource or assigning the virtual resource to a second workload domain to execute a workload.

19. The method of claim 15, wherein the virtual resource is a first virtual resource, the first virtual resource represents a first quantity of hardware resources, the operation is an upsize operation, the value of the utilization parameter satisfies the threshold based on the value being greater than the threshold, and the method further including:
determining that the first virtual resource is overutilized based on the value being greater than the threshold; and
at least one of transferring a portion of a workload of the first virtual resource to a second virtual resource or adding a second quantity of hardware resources to the first virtual resource.

20. The method of claim 15, wherein the virtual resource is powered off at a first time, and the method further including turning on the virtual resource to execute the operation at a second time after the first time.

21. The method of claim 15, wherein the utilization parameter is a compute utilization, a memory utilization, or a storage utilization.
